(19) United States
(12) Patent Application Publication
(10) Pub. No.: US 2025/0048370 A1
(43) Pub. Date: Feb. 6, 2025

(54) UPLINK TRANSMISSION METHOD AND APPARATUS, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Zuomin WU, Dongguan (CN)

(21) Appl. No.: 18/923,040

(22) Filed: Oct. 22, 2024

Related U.S. Application Data
(63) Continuation of application No. PCT/CN2022/090257, filed on Apr. 29, 2022.

(51) Int. Cl. H04W 72/21; H04L 5/00; H04W 74/0833

(52) U.S. Cl. CPC H04W 72/21; H04L 5/0005; H04W 74/0833

(57) ABSTRACT

Embodiments of this application provide an uplink transmission method and apparatus, a terminal device, and a network device. The method includes: receiving, by a terminal device, first configuration information sent by a network device, where the first configuration information is used to determine at least one uplink transmission format, the at least one uplink transmission format includes a first uplink transmission format, and the first uplink transmission format is different from a basic transmission format; and determining, by the terminal device, a target uplink transmission format from the at least one uplink transmission format, and sending uplink transmission based on the target uplink transmission format.

This application is a continuation of International Application No. PCT/CN2022/090257, filed on Apr. 29, 2022, the disclosure of which is hereby incorporated by reference in its entirety.

### TECHNICAL FIELD

Embodiments of this application relate to the field of mobile communications technologies, and in particular, to an uplink transmission method and apparatus, a terminal device, and a network device.

### BACKGROUND

In a mobile communications network, a coverage problem of a terminal device may arise for some reasons, for example, a relatively large propagation delay between the terminal device and a signal coverage device, and movement of the signal coverage device. To enable the terminal device to smoothly perform uplink transmission, an uplink coverage enhancement technology for the terminal device needs to be considered. The uplink coverage enhancement technology for the terminal device needs to be improved.

### SUMMARY

Embodiments of this application provide an uplink transmission method and apparatus, a terminal device, a network device, a chip, a computer-readable storage medium, a computer program product, and a computer program.

The uplink transmission method provided in embodiments of this application includes:
receiving, by a terminal device, first configuration information sent by a network device, where the first configuration information is used to determine at least one uplink transmission format, the at least one uplink transmission format includes a first uplink transmission format, and the first uplink transmission format is different from a basic transmission format; and
determining, by the terminal device, a target uplink transmission format from the at least one uplink transmission format, and sending uplink transmission based on the target uplink transmission format.

The uplink transmission method provided in embodiments of this application includes:
sending, by a network device, first configuration information to a terminal device, where the first configuration information is used to determine at least one uplink transmission format, the at least one uplink transmission format includes a first uplink transmission format, and the first uplink transmission format is different from a basic transmission format; and
receiving, by the network device, uplink transmission sent by the terminal device based on a target uplink transmission format, where the target uplink transmission format is determined from the at least one uplink transmission format.

The uplink transmission apparatus provided in embodiments of this application is applied to a terminal device, and the apparatus includes:
a receiving unit, configured to receive first configuration information sent by a network device, where the first configuration information is used to determine at least one uplink transmission format, the at least one uplink transmission format includes a first uplink transmission format, and the first uplink transmission format is different from a basic transmission format;
a processing unit, configured to determine a target uplink transmission format from the at least one uplink transmission format; and
a sending unit, configured to send uplink transmission based on the target uplink transmission format.

The uplink transmission apparatus provided in embodiments of this application is applied to a network device, and the apparatus includes:
a sending unit, configured to send first configuration information to a terminal device, where the first configuration information is used to determine at least one uplink transmission format, the at least one uplink transmission format includes a first uplink transmission format, and the first uplink transmission format is different from a basic transmission format; and
a receiving unit, configured to receive uplink transmission sent by the terminal device based on a target uplink transmission format, where the target uplink transmission format is determined from the at least one uplink transmission format.

The terminal device provided in embodiments of this application includes a processor and a memory. The memory is configured to store a computer program, and the processor is configured to invoke and run the computer program stored in the memory, to execute the foregoing uplink transmission method.

The network device provided in embodiments of this application includes a processor and a memory. The memory is configured to store a computer program, and the processor is configured to invoke and run the computer program stored in the memory, to execute the foregoing uplink transmission method.

The chip provided in embodiments of this application is configured to implement the foregoing uplink transmission method.

Specifically, the chip includes a processor, configured to invoke and run a computer program in a memory, to cause a device installed with the chip to execute the foregoing uplink transmission method.

The computer-readable storage medium provided in embodiments of this application is configured to store a computer program, and the computer program causes a computer to execute the foregoing uplink transmission method.

The computer program product provided in embodiments of this application includes computer program instructions, and the computer program instructions cause a computer to execute the foregoing uplink transmission method.

The computer program provided in embodiments of this application, when run on a computer, causes the computer to execute the foregoing uplink transmission method.

According to the foregoing technical solutions, a network device configures a first uplink transmission format for a terminal device. The first uplink transmission format is different from a basic transmission format, that is, the first uplink transmission format is a new uplink transmission format different from the basic transmission format.

### BRIEF DESCRIPTION OF DRAWINGS

The accompanying drawings described herein are used to provide a further understanding of this application, and constitute a part of this application. Exemplary embodiments of this application and descriptions thereof are provided for illustration, and do not constitute any improper limitation on this application. In the accompanying drawings:

FIG. 1A is a schematic diagram of an architecture of a communications system according to an embodiment of this application.

FIG. 1B is a schematic diagram of an architecture of another communications system according to an embodiment of this application.

FIG. 1C is a schematic diagram of an architecture of another communications system according to an embodiment of this application.

FIG. 2 is a schematic diagram of time domain resources occupied by some preamble formats according to an embodiment of this application.

FIG. 3 is a schematic diagram of time domain resources occupied by some other preamble formats according to an embodiment of this application.

FIG. 4 is a schematic flowchart of an uplink transmission method according to an embodiment of this application.

FIG. 5 is a schematic diagram of first segment time windows according to an embodiment of this application.

FIG. 6 is another schematic diagram of first segment time windows according to an embodiment of this application.

FIG. 7 is a schematic diagram of a structure of an uplink transmission apparatus according to an embodiment of this application.

FIG. 8 is a schematic diagram of a structure of another uplink transmission apparatus according to an embodiment of this application.

FIG. 9 is a schematic structural diagram of a communications device according to an embodiment of this application.

FIG. 10 is a schematic structural diagram of a chip according to an embodiment of this application.

FIG. 11 is a schematic block diagram of a communications system according to an embodiment of this application.

### DESCRIPTION OF EMBODIMENTS

The following describes the technical solutions in embodiments of this application with reference to the accompanying drawings in embodiments of this application. Apparently, the described embodiments are some rather than all of embodiments of this application. All other embodiments obtained by persons of ordinary skill in the art based on embodiments of this application without creative efforts fall within the protection scope of this application.

To facilitate understanding of the technical solutions in embodiments of this application, the following describes related technologies in embodiments of this application. The following related technologies may be randomly combined with the technical solutions in embodiments of this application as optional solutions, which are all within the protection scope of embodiments of this application.

In a mobile communications system, scenarios of the communications system include a terrestrial network (TN) and a non-terrestrial network (NTN). The NTN generally provides a communication service for a terrestrial user through satellite communication. The NTN may be combined with various communications systems. For example, the NTN may be combined with a new radio (NR) system to form an NR-NTN system. For another example, the NTN may be combined with the internet of things (IoT) system to form an IoT-NTN system.

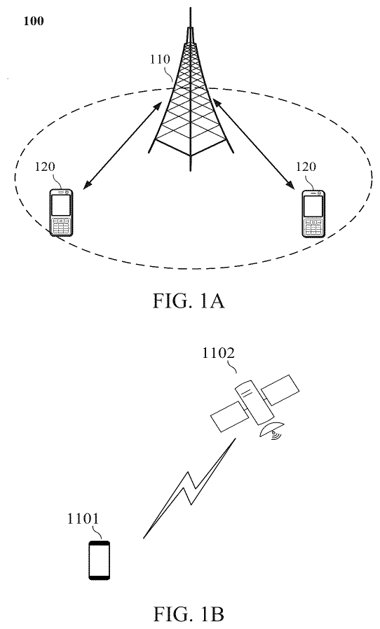

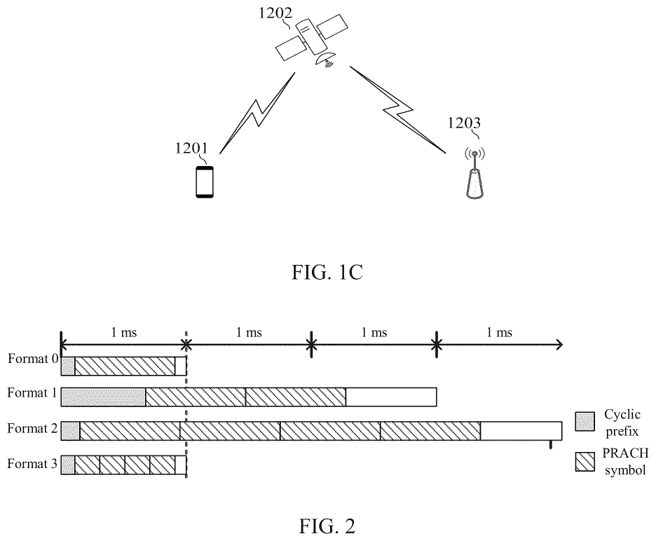

Exemplarily, FIG. 1A is a schematic diagram of an architecture of a communications system according to an embodiment of this application. As shown in FIG. 1A, a communications system 100 may include a network device 110, and the network device 110 may be a device that communicates with a terminal device 120 (or referred to as a communications terminal or a terminal). The network device 110 may provide communication coverage for a specific geographic area, and may communicate with a terminal device within the coverage area.

FIG. 1A exemplarily shows one network device and two terminal devices. In some embodiments of this application, the communications system 100 may include a plurality of network devices, and another quantity of terminal devices may be included within coverage of each network device, which is not limited in embodiments of this application.

Exemplarily, FIG. 1B is a schematic diagram of an architecture of another communications system according to an embodiment of this application. Referring to FIG. 1B, a terminal device 1101 and a satellite 1102 are included, and wireless communication may be performed between the terminal device 1101 and the satellite 1102. A network formed between the terminal device 1101 and the satellite 1102 may also be referred to as an NTN. In the architecture of the communications system shown in FIG. 1B, the satellite 1102 may have a function of a base station, and direct communication may be performed between the terminal device 1101 and the satellite 1102. In this system architecture, the satellite 1102 may be referred to as a network device. In some embodiments of this application, the communications system may include a plurality of network devices 1102, and another quantity of terminal devices may be included within coverage of each network device 1102, which is not limited in embodiments of this application.

Exemplarily, FIG. 1C is a schematic diagram of an architecture of another communications system according to an embodiment of this application. Referring to FIG. 1C, a terminal device 1201, a satellite 1202, and a base station 1203 are included, wireless communication may be performed between the terminal device 1201 and the satellite 1202, and communication may be performed between the satellite 1202 and the base station 1203. A network formed by the terminal device 1201, the satellite 1202, and the base station 1203 may also be referred to as an NTN. In the architecture of the communications system shown in FIG. 1C, the satellite 1202 may not have a function of a base station, and communication between the terminal device 1201 and the base station 1203 needs to be transferred through the satellite 1202. In this system architecture, the base station 1203 may be referred to as a network device. In some embodiments of this application, the communications system may include a plurality of network devices 1203, and another quantity of terminal devices may be included within coverage of each network device 1203, which is not limited in embodiments of this application.

The terminal devices in FIG. 1A to FIG. 1C may be any terminal device. For example, the terminal device may be an access terminal, user equipment (UE), a subscriber unit, a subscriber station, a mobile station, a mobile console, a remote station, a remote terminal, a mobile device, a user terminal, a terminal, a wireless communications device, a user agent, or a user apparatus. The access terminal may be a cellular phone, a cordless phone, a session initiation protocol (SIP) phone, an IoT device, a satellite handheld terminal, a wireless local loop (WLL) station, a personal digital assistant (DA), a handheld device with a wireless communication function, a computing device, another processing device connected to a wireless modem, an in-vehicle device, a wearable device, a terminal device in a 5G network, a terminal device in a future evolved network, or the like.

It should be noted that FIG. 1A to FIG. 1C are merely examples of systems to which this application is applicable. Certainly, the method shown in embodiments of this application may be further applicable to another system. In addition, the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects. It should also be understood that, the “indication” mentioned in embodiments of this application may be a direct indication or an indirect indication, or indicate an association relationship. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association relationship between A and B. It should be further understood that the term “corresponding” mentioned in embodiments of this application may mean that there is a direct or indirect correspondence between two elements, or that there is an association relationship between two elements, or that there is a relationship of “indicating” and “being indicated”, “configuring” and “being configured”, or the like. It should be further understood that the “predefining” or “predefined rule” mentioned in embodiments of this application may be implemented in a manner in which corresponding code, a table, or other related information used for indication is prestored in a device (for example, including a terminal device and a network device). A specific implementation is not limited in this application. For example, the “predefining” may refer to being defined in a protocol. It should be further understood that in embodiments of this application, the “protocol” may refer to a standard protocol in the communications field, for example, may include an LTE protocol, an NR protocol, and a related protocol applied to a future communications system. This is not limited in this application.

In an NTN system, a network device needs to send synchronization auxiliary information to a terminal device. The synchronization auxiliary information is used by the terminal device to complete time domain synchronization and/or frequency domain synchronization. The synchronization auxiliary information is used to indicate at least one of the following information: service satellite ephemeris information, a common timing advance (TA) parameter, reference moment indication information, or duration of a target timer.

The service satellite ephemeris information is used to determine position and velocity state (PVS) vector information of a service satellite.

The common TA parameter includes at least one of the following information: a common timing value (in units of s), an offset value of the common timing value (for example, a first derivative of the common timing value, in units of s/s), or a change rate of the offset value of the common timing value (for example, a second derivative of the common timing value, in units of s/s²).

The terminal device completes corresponding time domain synchronization and/or frequency domain synchronization based on the synchronization auxiliary information and a global navigation satellite system (GNSS) capability of the terminal device. For example, the terminal device may obtain at least one of the following information based on the GNSS capability of the terminal device: a location of the terminal device, a time reference, or a frequency reference. Based on the foregoing information and the synchronization auxiliary information, the terminal device may obtain timing and/or a frequency offset, and perform timing advance compensation and/or frequency offset adjustment in a radio resource control (RRC) idle state, an RRC inactive state, or an RRC connected state.

Because the synchronization auxiliary information changes with time, one or more timers need to be configured for the terminal device in the NTN system. The one or more timers may be used by the terminal device to determine whether the obtained synchronization auxiliary information is valid.

For example, the synchronization auxiliary information corresponds to a target timer. After the terminal device starts or restarts the target timer and before the target timer expires (or before duration of the target timer ends), the terminal device may assume that the synchronization auxiliary information obtained by the terminal device is valid.

In some cases, the terminal device may calculate a T_{TA} value based on the following formula 1, and determine timing of uplink transmission based on the determined T_{TA} value:

$${T}_{TA} = ( {N}_{TA} + {N}_{TA , offset} + {N}_{TA , {adj}^{common}} + {N}_{TA , {adj}^{UE}} ) * Tc , \qquad ( Formula 1 )$$

where if uplink transmission is physical random access channel (Physical Random Access Channel, PRACH) transmission or message A (MsgA) transmission, a value of N_{TA} is 0, or otherwise, a value of N_{TA} is a TA value indicated by the network device; N_{TA, offset} is determined based on whether a frequency band configured for the network coexists with LTE or NR; N_{TA,adj}^{common} is obtained based on a common TA parameter configured by a higher layer (for example, a common timing value, an offset value of the common timing value, or a change rate of the offset value of the common timing value), where if the higher layer does not configure the common TA parameter, a value of N_{TA,adj}^{common} is 0; N_{TA,adj}^{UE} is calculated by the terminal device based on the location of the terminal device and the service satellite ephemeris information configured by the higher layer, where if the higher layer does not configure the service satellite ephemeris information, a value of N_{TA,adj}^{UE} is 0; and Tc represents a time unit of sampling interval, and Tc=1/(480*1000*4096). Herein, the higher layer configuration may be an RRC configuration.

In an NR system and an evolved system thereof, a random access process (also referred to as a random access channel (RACH) process) includes two cases: a 4-step RACH (4-step RACH) process and a 2-step RACH (2-step RACH) process. A delay of the 4-step RACH process is relatively large. Compared with the 4-step RACH process, the 2-step RACH process can reduce an access delay.

For the 4-step RACH process, the following steps are included.
Step 1: The terminal device sends a preamble (Preamble), that is, a message 1 (message 1, Msg1), to the network device by using a PRACH.
Step 2: After detecting that the terminal device sends the preamble, the network device sends a random access response (RAR), that is, a message 2 (Msg2), to the terminal device. The RAR is used to notify the terminal device of uplink resource information that can be used for sending a message 3 (Msg3), allocate a temporary cell-radio network temporary identifier (TC-RNTI) to the terminal device, provide a TA command (TA command) for the terminal device, and the like.
Step 3: After receiving the RAR, the terminal device sends a physical uplink shared channel (Physical Uplink Shared Channel, PUSCH), that is, the message 3 (message 3, Msg3), on an uplink resource specified by the RAR. Herein, the PUSCH may be referred to as a Msg3-PUSCH.
Step 4: The network device sends a message 4 (message 4, Msg4) to the terminal device, where the Msg4 may include a contention resolution message.

After receiving the Msg4, the terminal device feeds back acknowledgement (ACK) information corresponding to the Msg4 to the network device, so as to complete a random access process.

For the 2-step RACH process, the following steps are included.
Step 1: The terminal device sends a message A (message A, MsgA) to the network device by using a PRACH and a PUSCH. The PRACH is used to send a preamble. It may be understood that the MsgA includes a preamble and a PUSCH. Herein, the PUSCH may be referred to as a msgA-PUSCH.
Step 2: After detecting the MsgA, the network device sends an RAR, that is, a message B (message B, MsgB), to the terminal device.

After receiving the MsgB, the terminal device feeds back ACK information corresponding to the MsgB to the network device, so as to complete a random access process.

Preamble formats supported in the NR system include formats 0, 1, 2, 3, A1, A2, A3, B1, B2, B3, B4, C0, and C2. Sequence lengths supported by the formats 0, 1, 2, and 3 are 839; and sequence lengths supported by the formats A1, A2, A3, B1, B2, B3, B4, C0, and C2 include 139, 1151, and 571. Subcarrier spacings supported by the formats 0, 1, and 2 are 1.25 kHz; a subcarrier spacing supported by the format 3 is 5 kHz; and subcarrier spacings supported by the formats A1, A2, A3, B1, B2, B3, B4, C0, and C2 include 15 kHz, 30 kHz, 60 kHz, 120 kHz, 480 kHz, and 960 kHz.

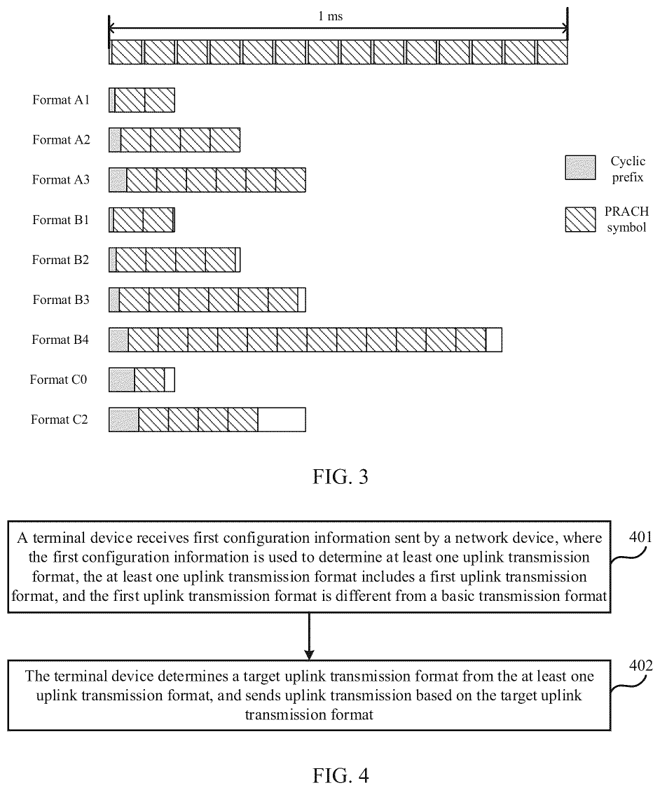

FIG. 2 and FIG. 3 are schematic diagrams of time domain resources occupied by a plurality of preamble formats. In FIG. 2 and FIG. 3, a preamble format includes a cyclic prefix (Cyclic Prefix, CP) and a sequence (Sequence), and a time domain resource of the sequence occupies one or more PRACH symbols.

It should be noted that the preamble format may also be referred to as a PRACH format or a PRACH preamble format (PRACH preamble format).

A resource used for transmitting a PRACH is referred to as a RACH occasion (RACH Occasion, RO) or a PRACH resource. The terminal device determines a corresponding PRACH transmission parameter configuration based on a PRACH configuration index (PRACH Configuration Index) notified by the network device. For example, the following Table 1 provides a correspondence between a PRACH configuration index and a PRACH transmission parameter configuration.

TABLE 1

| | | | | | | Number | Nₜ^{RA, slot}, | |
|---|---|---|---|---|---|---|---|---|
| | | | | | | of | number | |
| | | | | | | PRACH | of ROs | |
| PRACH | | n_{SFN} mod | | | | slots | within a | N_{dur}^{RA}, |
| configuration | Preamble | x = y | | Subframe | Starting | within a | PRACH | PRACH |
| index | format | x | y | number | symbol | subframe | slot | duration |
| 0 | 0 | 16 | 1 | 1 | 0 | — | — | 0 |
| 1 | 0 | 16 | 1 | 4 | 0 | — | — | 0 |
| 2 | 0 | 16 | 1 | 7 | 0 | — | — | 0 |
| 3 | 0 | 16 | 1 | 9 | 0 | — | — | 0 |
| 4 | 0 | 8 | 1 | 1 | 0 | — | — | 0 |
| 5 | 0 | 8 | 1 | 4 | 0 | — | — | 0 |
| 6 | 0 | 8 | 1 | 7 | 0 | — | — | 0 |
| . . . | . . . | . . . | . . . | . . . | . . . | . . . | . . . | . . . |

According to the foregoing Table 1, the terminal device may determine information such as a preamble format, a PRACH repetition period (that is, x), and a PRACH time domain resource based on the PRACH configuration index. PRACH time domain resource information is used to determine a time domain location of a PRACH resource, including a radio frame (that is, nSFN) or a subframe (FR 1)/a slot (FR 2) in which the PRACH resource is located, a quantity of PRACH slots included in one subframe/slot (for the FR 1, one subframe may include a maximum of two PRACH slots, and for the FR 2, one slot of 60 kHz may include a maximum of two PRACH slots), a quantity of ROs included in one PRACH slot (a product of a quantity of ROs included in one PRACH slot and a length of PRACH in this format is not greater than 14, that is, within one slot), a starting symbol of a PRACH, and the like.

The terminal device determines frequency domain locations of PRACH resources based on a PRACH resource frequency domain start location configuration parameter (for example, a higher layer parameter msg1-FrequencyStart or msgA-RO-FrequencyStart) notified by the network device and a quantity of PRACH resources for frequency division multiplexing (FDM) on a same time unit.

The PRACH transmission parameter configuration may be configured by using system information or dedicated RRC signalling.

In the NR system, there is an association relationship between an RO and a synchronization signal and physical broadcast channel block (Synchronization Signal and PBCH Block, SSB). After determining a target SSB, the terminal device may transmit a PRACH based on an RO associated with the target SSB. Specifically, an association rule between an RO and an SSB is as follows:

(I) Each RO is associated with N SSBs, each SSB corresponds to R preambles used for contention access, N is a positive integer or 1/N is a positive integer, and R is a positive integer.

When N<1, one SSB is associated with a plurality of (that is, 1/N) ROs.

When N=1, one SSB is associated with one RO.

When N>1, a plurality of SSBs (that is, N SSBs) are associated with one RO.

(II) Preambles corresponding to each SSB may be divided into a group A and a group B.

(III) There are N*R preambles used for contention access in total.

(IV) An arrangement order of preambles, ROs, and SSBs is as follows:
Case 1: Preambles are arranged in an ascending order of preamble indexes within each RO, second, ROs for frequency division multiplexing are arranged in an ascending order of frequency domain resource indexes, and finally, ROs for time division multiplexing are arranged in an ascending order of time domain resource indexes. Based on this arrangement order and with reference to values of the foregoing parameters N and R, an association relationship between an SSB and an RO and/or a preamble may be determined. Herein, that ROs for time division multiplexing are arranged in an ascending order of time domain resource indexes may further include: time domain resource indexes of ROs for time domain multiplexing in each PRACH slot are arranged in an ascending order; and PRACH slot indexes are arranged in an ascending order.
Case 2: In a case that a physical downlink control channel (PDCCH) order indicates a preamble index and a preamble mask index, first, ROs for frequency division multiplexing are arranged in an ascending order of frequency domain resource indexes, and second, ROs for time division multiplexing are arranged in an ascending order of time domain resource indexes. Based on this arrangement order and with reference to values of the foregoing parameters N and R, an association relationship between an SSB and an RO and/or a preamble may be determined. Herein, that ROs for time division multiplexing are arranged in an ascending order of time domain resource indexes may further include: time domain resource indexes of ROs for time domain multiplexing in each PRACH slot are arranged in an ascending order; and PRACH slot indexes are arranged in an ascending order.

An association relationship between ROs and SSBs is repeated periodically, and a maximum period is 160 ms. Within one period, an association relationship between an SSB and its corresponding RO recurrently appears for an integer of times.

In the NTN network, because of characteristics of the NTN network such as a relatively large signal propagation delay and movement of a satellite, a coverage problem of the terminal device may arise. In an evolved NTN network, to enable the terminal device to successfully access a network, an uplink coverage enhancement technology for the terminal device in an initial access phase needs to be considered. Therefore, a new preamble format is introduced in the NTN network, and the new preamble format may enable the terminal device to transmit a preamble in time domain for a relatively long time. However, after the new preamble format is introduced, it is not clear how to configure the new preamble format in the NTN network, how the terminal device selects a preamble format, and how the terminal device transmits a preamble based on the new preamble format. Therefore, the following technical solutions in embodiments of this application are proposed.

It should be noted that, although the foregoing describes the related technologies of the NTN network, the technical solutions in embodiments of this application is not limited to being applied to the NTN network, but may also be applied to another type of network.

It should be noted that, although the foregoing describes related technologies of the preamble format (that is, a PRACH format or a PRACH preamble format) and preamble transmission (that is, PRACH transmission), the technical solutions in embodiments of this application cover but are not limited to the solutions for the preamble format and the preamble transmission.

To facilitate understanding of the technical solutions in embodiments of this application, the following describes the technical solutions in this application in detail with reference to specific embodiments. The foregoing related technologies, as optional solutions, may be randomly combined with the technical solutions of embodiments of this application, all of which fall within the protection scope of embodiments of this application. Embodiments of this application include at least a part of the following content.

FIG. 4 is a schematic flowchart of an uplink transmission method according to an embodiment of this application. As shown in FIG. 4, the uplink transmission method includes the following steps.

Step 401: A terminal device receives first configuration information sent by a network device, where the first configuration information is used to determine at least one uplink transmission format, the at least one uplink transmission format includes a first uplink transmission format, and the first uplink transmission format is different from a basic transmission format.

In this embodiment of this application, the network device sends the first configuration information to the terminal device. Correspondingly, the terminal device receives the first configuration information sent by the network device. In some embodiments, the network device may be a base station or a satellite having a function of a base station.

Step 402: The terminal device determines a target uplink transmission format from the at least one uplink transmission format, and sends uplink transmission based on the target uplink transmission format.

In this embodiment of this application, the terminal device determines the target uplink transmission format from the at least one uplink transmission format, and sends the uplink transmission based on the target uplink transmission format. Correspondingly, the network device receives the uplink transmission sent by the terminal device based on the target uplink transmission format, where the target uplink transmission format is determined from the at least one uplink transmission format.

In some embodiments, the description of “uplink transmission” may also be replaced with “uplink signal or uplink channel”. The description of “uplink transmission format” may also be replaced with “uplink signal format or uplink channel format”.

In some embodiments, the uplink transmission is uplink transmission in an RRC idle state or an RRC inactive state; or the uplink transmission is uplink transmission performed before dedicated RRC signalling is configured. For example, the uplink transmission may be uplink transmission in a random access process, for example, a PRACH, a MsgA (including a PRACH and/or a MsgA-PUSCH), a Msg3-PUSCH, or a configured grant PUSCH (CG-PUSCH). The CG-PUSCH may be but is not limited to a MsgA-PUSCH and/or a CG-PUSCH configured for transmission of a small packet.

In some embodiments, the first configuration information is configured by using at least one of the following signalling: system information, RRC signalling, a media access control (MAC) control element (CE), or downlink control information (DCI).

For example, if the uplink transmission is uplink transmission performed after dedicated RRC signalling is configured, the first configuration information is configured by using RRC signalling; and/or if the uplink transmission is uplink transmission performed before dedicated RRC signalling is configured, the first configuration information is configured by using system information. For another example, regardless of whether the uplink transmission is uplink transmission performed before dedicated RRC signalling is configured or uplink transmission performed after dedicated RRC signalling is configured, the first configuration information is configured by using system information.

Optionally, the first configuration information is configured by using a system information block 1 (SIB 1) or configured by using an NTN-SIB.

Optionally, the first configuration information includes one or more pieces of information. The information herein may be understood as a parameter. In other words, the first configuration information may be configured by using one or more parameters.

In some embodiments, the first configuration information is used to determine a configuration parameter of the at least one uplink transmission format, the at least one uplink transmission format includes the first uplink transmission format, and the first uplink transmission format is different from the basic transmission format. The terminal device determines the configuration parameter of the at least one uplink transmission format based on the first configuration information.

Optionally, a quantity of configuration parameters is configured in the first configuration information, or is predefined.

For example, the configuration parameter may include at least one of the following information: a configuration index, an uplink transmission format, an uplink transmission repetition period, time domain resource information of uplink transmission, or the like. The configuration index is used to identify an index of the configuration parameter. The uplink transmission format is an uplink transmission format corresponding to the configuration parameter. The uplink transmission repetition period is a repetition period of uplink transmission. The time domain resource information of uplink transmission is used to determine a time domain resource of uplink transmission, and includes at least one of the following information: a radio frame or a subframe/slot in which an uplink transmission resource is located, a quantity of uplink transmission slots included in one subframe/slot, a quantity of uplink transmission occasions included in one uplink transmission slot, a starting symbol of uplink transmission, a length of uplink transmission, or the like. In addition, the terminal device may determine a frequency domain location of an uplink transmission resource based on a configuration parameter of a frequency domain start location of an uplink transmission resource and notified by the network device and a quantity of uplink transmission resources for frequency division multiplexing on a same time unit.

In this embodiment of this application, the at least one uplink transmission format includes the first uplink transmission format, and the first uplink transmission format is different from the basic transmission format. Optionally, the first uplink transmission format includes one or more transmission formats; and/or the basic transmission format includes one or more transmission formats.

Compared with the basic transmission format, the first uplink transmission format may be understood as a new uplink transmission format, an uplink transmission format that supports a coverage enhancement scenario, or an uplink transmission format that supports repeated transmission. The basic transmission format may be understood as an existing uplink transmission format or a conventional uplink transmission format.

For example, in an example in which the uplink transmission is PRACH transmission, the basic transmission format includes at least one of the following: a PRACH format 0, a PRACH format 1, a PRACH format 2, a PRACH format 3, a PRACH format A1, a PRACH format A2, a PRACH format A3, a PRACH format B1, a PRACH format B2, a PRACH format B3, a PRACH format B4, a PRACH format C0, or a PRACH format C2. Herein, for the basic transmission format, refer to the foregoing descriptions of the related solution. For example, FIG. 2 and FIG. 3 are schematic diagrams of time domain resources occupied by the basic transmission format. The first uplink transmission format includes a format Dx. Herein, Dx is merely an example name, and may be replaced by another name.

For example, in an example in which the uplink transmission is Msg3-PUSCH transmission, the basic transmission format includes a Msg3-PUSCH transmission mode that does not support repeated transmission, and the first uplink transmission format includes a Msg3-PUSCH transmission mode that supports repeated transmission.

In some embodiments, the first uplink transmission format is an uplink transmission format applied to a coverage enhancement scenario. When uplink transmission is performed by using the first uplink transmission format, uplink transmission of a specific time length may be transmitted (for example, repeatedly transmitted), so as to meet a coverage enhancement requirement.

In some embodiments, uplink transmission corresponding to the first uplink transmission format is P times of repeated uplink transmission corresponding to the basic transmission format, and P is a positive integer; or a time length corresponding to the first uplink transmission format is P times a time length corresponding to the basic transmission format, and P is a positive integer.

In some embodiments, the at least one uplink transmission format further includes a second uplink transmission format, and the second uplink transmission format is the same as the basic transmission format or the second uplink transmission format is different from the basic transmission format. Optionally, the second uplink transmission format includes one or more transmission formats.

In a case that the second uplink transmission format is the same as the basic transmission format, the first uplink transmission format may be understood as a new uplink transmission format, and the second uplink transmission format may be understood as an existing uplink transmission format or a conventional uplink transmission format.

In some embodiments, the first uplink transmission format is an uplink transmission format applied to a coverage enhancement scenario, and the second uplink transmission format is an uplink transmission format applied to a coverage non-enhancement scenario.

In a case that the second uplink transmission format is different from the basic transmission format, both the first uplink transmission format and the second uplink transmission format may be understood as new uplink transmission formats, and the first uplink transmission format and the second uplink transmission format are different new uplink transmission formats.

In some embodiments, both the first uplink transmission format and the second uplink transmission format are uplink transmission formats applied to coverage enhancement scenarios. The first uplink transmission format and the second uplink transmission format correspond to different coverage enhancement scenarios, different coverage enhancement levels, or different satellite deployment scenarios (for example, a GEO, an MEO, or an LEO).

For example, in an example in which the uplink transmission is PRACH transmission, the basic transmission format includes at least one of the following: a PRACH format 0, a PRACH format 1, a PRACH format 2, a PRACH format 3, a PRACH format A1, a PRACH format A2, a PRACH format A3, a PRACH format B1, a PRACH format B2, a PRACH format B3, a PRACH format B4, a PRACH format C0, or a PRACH format C2. Herein, for the basic transmission format, refer to the foregoing descriptions of the related solution. For example, FIG. 2 and FIG. 3 are schematic diagrams of time domain resources occupied by the basic transmission format. The first uplink transmission format includes a format Dx, and the second uplink transmission format includes a format Dy. Herein, Dx and Dy are merely example names, and may be replaced by other names.

In some embodiments, uplink transmission corresponding to the first uplink transmission format is M times of repeated uplink transmission corresponding to the second uplink transmission format, and M is an integer greater than or equal to 2.

For example, in an example in which the uplink transmission is PRACH transmission, the second uplink transmission format includes a PRACH format 0, and a transmission format included in the first uplink transmission format is M times of repeated transmission in the PRACH format 0. For another example, the second uplink transmission format includes a PRACH format 2, and a transmission format included in the first uplink transmission format is M times of repeated transmission in the PRACH format 2.

For example, the second uplink transmission format includes a format Dy, and a format Dx included in the first uplink transmission format is M times of repeated transmission in the format Dy.

Optionally, a value of M is configured in the first configuration information, or is predefined, or is determined based on a value set of M configured in the first configuration information.

Herein, in a case that the first configuration information configures the value of M or the value set of M, a parameter for configuring the value of M or the value set of M may be the same as or different from a parameter for configuring the at least one uplink transmission format.

In some embodiments, uplink transmission corresponding to the first uplink transmission format is P times of repeated uplink transmission corresponding to the basic transmission format, uplink transmission corresponding to the second uplink transmission format is Q times of repeated uplink transmission corresponding to the basic transmission format, P and Q are both positive integers, and values of P and Q are different.

For example, in an example in which the uplink transmission is PRACH transmission, the basic transmission format includes a PRACH format 0, a transmission format included in the first uplink transmission format is P times of repeated transmission in the PRACH format 0, and a transmission format included in the second uplink transmission format is Q times of repeated transmission in the PRACH format 0. For another example, the basic transmission format includes a PRACH format 2, a transmission format included in the first uplink transmission format is P times of repeated transmission in the PRACH format 2, and a transmission format included in the second uplink transmission format is Q times of repeated transmission in the PRACH format 2. For another example, the basic transmission format includes a PRACH format 0 and a PRACH format 2, a transmission format included in the first uplink transmission format is P times of repeated transmission in the PRACH format 0, and a transmission format included in the second uplink transmission format is Q times of repeated transmission in the PRACH format 2.

Optionally, a value of P is configured in the first configuration information, or is predefined, or is determined based on a value set of P configured in the first configuration information.

Optionally, a value of Q is configured in the first configuration information, or is predefined, or is determined based on a value set of Q configured in the first configuration information.

Herein, in a case that the first configuration information configures the value of P and/or Q or the value set of P and/or Q, a parameter for configuring the value of P and/or Q or the value set of P and/or Q may be the same as or different from a parameter for configuring the at least one uplink transmission format.

In this embodiment of this application, after determining the at least one uplink transmission format based on the first configuration information, the terminal device determines the target uplink transmission format from the at least one uplink transmission format.

In some embodiments, the terminal device determines the target uplink transmission format from the at least one uplink transmission format independently.

In an optional implementation, the terminal device determines the target uplink transmission format from the at least one uplink transmission format based on measured signal strength.

Optionally, the terminal device determines, based on at least one signal strength threshold, a signal strength range to which the measured signal strength belongs, and determines the target uplink transmission format from the at least one uplink transmission format based on the signal strength range to which the signal strength belongs.

Optionally, the at least one signal strength threshold is used to determine at least two signal strength ranges, and each of the at least two signal strength ranges corresponds to a respective uplink transmission format.

Optionally, the at least one signal strength threshold is configured in the first configuration information, or is predefined, or is determined based on a value set of a signal strength threshold configured in the first configuration information.

For example, the first configuration information is used to determine configuration parameters of K uplink transmission formats, and is used to determine J signal strength thresholds, where K and J are positive integers. Signal strength of a scenario corresponding to the k^{th} uplink transmission format is better than signal strength of a scenario corresponding to the (k−1)th uplink transmission format, the 1^{st} uplink transmission format corresponds to a scenario with the worst signal strength, the K^{th} uplink transmission format corresponds to a scenario with the best signal strength, and the j^{th} signal strength threshold is lower than the (j+1)^{th} signal strength threshold, where k is a positive integer greater than or equal to 2 and less than or equal to K, and j is a positive integer greater than or equal to 1 and less than or equal to J−1. Optionally, J=K−1.

Optionally, if signal strength measured by the terminal device is less than the 1^{st} signal strength threshold, the 1^{st} uplink transmission format is selected; or if signal strength measured by the terminal device is greater than or equal to the 1^{st} signal strength threshold and is less than the 2^{nd} signal strength threshold, the 2^{nd} uplink transmission format is selected; by analogy, if signal strength measured by the terminal device is greater than or equal to the (K−2)^{th} signal strength threshold and is less than the (K−1)^{th} signal strength threshold, the (K−1)^{th} uplink transmission format is selected; or if signal strength measured by the terminal device is greater than or equal to the (K−1)^{th} signal strength threshold, the K^{th} uplink transmission format is selected.

Optionally, if signal strength measured by the terminal device is less than or equal to the 1^{st} signal strength threshold, the 1^{st} uplink transmission format is selected; or if signal strength measured by the terminal device is greater than the 1^{st} signal strength threshold and less than or equal to the 2^{nd} signal strength threshold, the 2^{nd} uplink transmission format is selected; by analogy, if signal strength measured by the terminal device is greater than the (K−2)^{th} signal strength threshold and is less than or equal to the (K−1)^{th} signal strength threshold, the (K−1)^{th} uplink transmission format is selected; or if signal strength measured by the terminal device is greater than the (K−1)^{th} signal strength threshold, the K^{th} uplink transmission format is selected.

In an optional implementation, the terminal device determines the target uplink transmission format from the at least one uplink transmission format based on a current coverage enhancement scenario, a current coverage enhancement level, or a current satellite deployment scenario. There is a correspondence between a coverage enhancement scenario or a coverage enhancement level or a satellite deployment scenario and an uplink transmission format. Optionally, the correspondence may be configured in the first configuration information, or may be predefined.

In some embodiments, the network device indicates the target uplink transmission format to the terminal device. Correspondingly, the terminal device determines the target uplink transmission format from the at least one uplink transmission format based on the indication from the network device.

In an optional implementation, the network device sends downlink control information to the terminal device. Correspondingly, the terminal device determines the target uplink transmission format from the at least one uplink transmission format based on the downlink control information sent by the network device, where the downlink control information is used to indicate the target uplink transmission format. Optionally, a DCI format corresponding to the downlink control information includes at least one of the following: a DCI format 1_0, a DCI format 1_1, a DCI format 1_2, a DCI format 0_0, a DCI format 01, or a DCI format 0_2.

In an optional implementation, the network device sends a PDCCH order to the terminal device. Correspondingly, the terminal device determines the target uplink transmission format from the at least one uplink transmission format based on the PDCCH order sent by the network device, where the uplink transmission is PRACH transmission, and the PDCCH order is used to indicate a target PRACH transmission format corresponding to the PRACH transmission.

For example, the network device sends a PDCCH order to the terminal device, where the PDCCH order is used to trigger PRACH transmission, the PDCCH order is used to indicate a target PRACH transmission format corresponding to the PRACH transmission, and/or the PDCCH order is used to indicate a number of times of repeated transmission corresponding to the PRACH transmission.

To enhance uplink coverage of the terminal device, repeated uplink transmission of the terminal device needs to be supported for uplink transmission. The introduction of repeated uplink transmission causes a relatively long transmission time of uplink transmission of the terminal device, and due to movement of a signal coverage device (for example, a satellite in an NTN network environment is moving), uplink synchronization of the terminal device does not meet a precision requirement, resulting in performance degradation of uplink transmission. Therefore, the terminal device needs to perform time domain synchronization adjustment and/or frequency domain synchronization adjustment in an uplink transmission process.

In some embodiments, the first uplink transmission format corresponds to a first segment length, and the first segment length is used to determine a first segment time window (also referred to as a segment time domain window). Before sending the uplink transmission by using the first segment time window, the terminal device performs time domain synchronization adjustment and/or frequency domain synchronization adjustment on the uplink transmission to be transmitted within the first segment time window. Optionally, the performing time domain synchronization adjustment and/or frequency domain synchronization adjustment includes: performing the time domain synchronization adjustment and/or frequency domain synchronization adjustment based on at least one of a location of the terminal device, a common timing parameter configured by the network device, and service satellite ephemeris information configured by the network device. For example, the terminal device may calculate a T_{TA} value based on the foregoing formula 1, and determine timing of uplink transmission based on the determined T_{TA} value, so as to perform time domain synchronization adjustment.

Optionally, the first segment length is predefined, or is determined based on a predefined rule, or is configured in the first configuration information.

Optionally, the first segment time window is determined based on at least two of a transmission start time, a transmission end time, and transmission duration of the uplink transmission. For example, a transmission time range of the uplink transmission is determined based on at least two of the transmission start time, the transmission end time, and the transmission duration of the uplink transmission, and the transmission time range is divided into one or more first segment time windows. Optionally, in addition to being based on the transmission time range, a division rule for the first segment time windows may be based on a length of the first segment time windows and/or a quantity of the first segment time windows, where the length of the first segment time windows and/or the quantity of the first segment time windows may be configured in the first configuration information, or may be predefined.

For example, in an example in which the uplink transmission is PRACH transmission, FIG. 5 is a schematic diagram of first segment time windows. There are a total of eight times of repeated PRACH transmission, and the eight times of repeated PRACH transmission may be continuous or partially discontinuous or all discontinuous. A PRACH transmission start time is a start time of a time domain resource corresponding to PRACH 1, and a PRACH transmission end time is an end time of a time domain resource corresponding to PRACH 8. A PRACH transmission time range may be determined based on the PRACH transmission start time and the PRACH transmission end time, and the entire PRACH transmission time range is divided into one or more first segment time windows. It may be learned that the first segment time window may include a valid RO resource and/or an invalid RO resource. The valid RO resource may be understood as an RO resource used for PRACH transmission, and the invalid RO resource may be understood as an RO resource not used for PRACH transmission. Optionally, in addition to being based on the PRACH transmission time range, a division rule of the first segment time window may be based on a length of a first segment time window and/or a quantity of first segment time windows, where the length of the first segment time window and/or the number of first segment time windows may be configured in the first configuration information, or may be predefined.

Optionally, the first segment time window is determined based on an effective transmission time of the uplink transmission. For example, a continuous effective transmission time of the uplink transmission is divided into one first segment time window, so that one or more first segment time windows can be obtained through division.

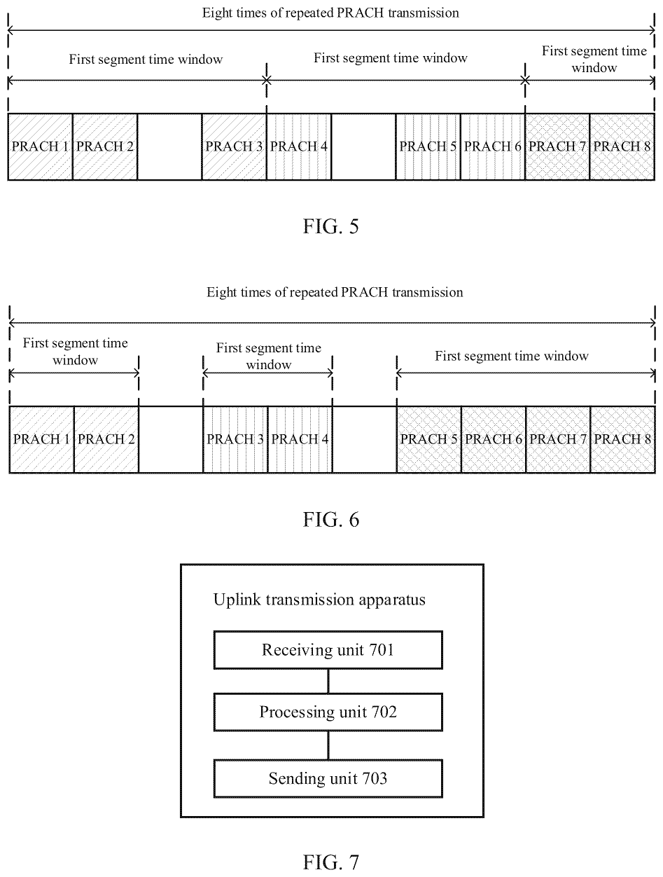

For example, in an example in which the uplink transmission is PRACH transmission, FIG. 6 is a schematic diagram of first segment time windows. There are a total of eight times of repeated PRACH transmission, and the eight times of repeated PRACH transmission may be continuous or partially discontinuous or all discontinuous. The effective transmission time of the uplink transmission includes a transmission time range corresponding to the eight times of repeated PRACH transmission. A transmission time range corresponding to a PRACH 1 and a PRACH 2 is a segment of continuous effective transmission time, and this segment of continuous effective transmission time is divided into one first segment time window; a transmission time range corresponding to a PRACH 3 and a PRACH 4 is a segment of continuous effective transmission time, and this segment of continuous effective transmission time is divided into one first segment time window; and a transmission time range corresponding to a PRACH 5 to a PRACH 8 is a segment of continuous effective transmission time, and this segment of continuous effective transmission time is divided into one first segment time window.

It should be noted that the solution of “segment length/segment time window” may be applied not only to the first uplink transmission format, but also to another uplink transmission format configured in the first configuration information, for example, the second uplink transmission format. For example, for the first uplink transmission format, the first uplink transmission format corresponds to a first segment length, and the first segment length is used to determine a first segment time window; and before sending the uplink transmission within the first segment time window based on the first uplink transmission format, the terminal device performs time domain synchronization adjustment and/or frequency domain synchronization adjustment on the uplink transmission to be transmitted within the first segment time window. For another example, for the second uplink transmission format, the second uplink transmission format corresponds to a second segment length, and the second segment length is used to determine a second segment time window; and before sending the uplink transmission within the second segment time window based on the second uplink transmission format, the terminal device performs time domain synchronization adjustment and/or frequency domain synchronization adjustment on the uplink transmission to be transmitted within the second segment time window.

In some embodiments, in a case that the uplink transmission is PRACH transmission, after sending the uplink transmission to the network device, the terminal device receives an RAR sent by the network device, sends a Msg3-PUSCH to the network device, receives a Msg4 sent by the network device, and then sends ACK/NACK information corresponding to the Msg4 to the network device by using a physical uplink control channel (PUCCH) (refer to the foregoing descriptions about the 4-step RACH process).

It may be learned that there is a correspondence among uplink transmission (or PRACH transmission), an RAR, a Msg3-PUSCH, a Msg4, and a PUCCH.

In some embodiments, the uplink transmission is PRACH transmission; and an RAR format corresponding to the first uplink transmission format is the same as an RAR format corresponding to the second uplink transmission format, In other words, both the first uplink transmission format and the second uplink transmission format correspond to a same RAR format.

In some embodiments, the uplink transmission is PRACH transmission; and an RAR format corresponding to the first uplink transmission format is a first RAR format, an RAR format corresponding to the second uplink transmission format is a second RAR format, and the first RAR format is different from the second RAR format and/or an information field in an uplink grant included in the first RAR format is different from an information field in an uplink grant included in the second RAR format and/or a PUCCH resource configuration corresponding to the first RAR format is different from a PUCCH resource configuration corresponding to the second RAR format. For example, a PUCCH resource configuration corresponding to PUCCH resource indication information included in the first RAR format is different from a PUCCH resource configuration corresponding to PUCCH resource indication information included in the second RAR format. Herein, the PUCCH resource configuration is used to determine a time domain resource and/or a frequency domain resource of a PUCCH.

In some embodiments, the uplink transmission is PRACH transmission; and a number of times of repeated Msg3-PUSCH transmission corresponding to the first uplink transmission format is different from a number of times of repeated Msg3-PUSCH transmission corresponding to the second uplink transmission format; or a number of times of repeated Msg3-PUSCH transmission corresponding to the first uplink transmission format is the same as a number of times of repeated Msg3-PUSCH transmission corresponding to the second uplink transmission format.

In some embodiments, the uplink transmission is PRACH transmission; and a configuration set of a number of times of repeated Msg3-PUSCH transmission corresponding to the first uplink transmission format is different from a configuration set of a number of times of repeated Msg3-PUSCH transmission corresponding to the second uplink transmission format; or a configuration set of a number of times of repeated Msg3-PUSCH transmission corresponding to the first uplink transmission format is the same as a configuration set of a number of times of repeated Msg3-PUSCH transmission corresponding to the second uplink transmission format, where the configuration set of the number of times of repeated Msg3-PUSCH transmission is used to determine the number of times of repeated Msg3-PUSCH transmission.

In some embodiments, there is an association relationship between uplink transmission formats corresponding to at least two of a PRACH, a Msg3-PUSCH, and a PUCCH. For example, when a target uplink transmission format corresponding to the PRACH is the first uplink transmission format (for example, an uplink transmission format that supports repeated transmission), uplink transmission formats corresponding to the Msg3-PUSCH and the PUCCH are also the uplink transmission format that supports repeated transmission. For another example, when a target uplink transmission format corresponding to the PRACH is the second uplink transmission format (for example, an uplink transmission format that does not support repeated transmission), uplink transmission formats corresponding to the Msg3-PUSCH and the PUCCH are also the uplink transmission format that does not support repeated transmission.

In some embodiments, in a case that the uplink transmission is MsgA transmission, after sending the uplink transmission to the network device, the terminal device receives an RAR sent by the network device, and then sends ACK/NACK information corresponding to the RAR to the network device by using a PUCCH (refer to the foregoing descriptions about the 2-step RACH process).

It may be learned that there is a correspondence among uplink transmission (or MsgA transmission), an RAR, and a PUCCH.

In some embodiments, the uplink transmission is MsgA transmission; and an RAR format corresponding to the first uplink transmission format is the same as an RAR format corresponding to the second uplink transmission format, in other words, both the first uplink transmission format and the second uplink transmission format correspond to a same RAR format.

In some embodiments, the uplink transmission is MsgA transmission; and an RAR format corresponding to the first uplink transmission format is a first RAR format, an RAR format corresponding to the second uplink transmission format is a second RAR format, and the first RAR format is different from the second RAR format and/or a PUCCH resource configuration corresponding to the first RAR format is different from a PUCCH resource configuration corresponding to the second RAR format. For example, a PUCCH resource configuration corresponding to PUCCH resource indication information included in the first RAR format is different from a PUCCH resource configuration corresponding to PUCCH resource indication information included in the second RAR format. Herein, the PUCCH resource configuration is used to determine a time domain resource and/or a frequency domain resource of a PUCCH.

In some embodiments, there is an association relationship between uplink transmission formats corresponding to a MsgA and a PUCCH. For example, when a target uplink transmission format corresponding to the MsgA is the first uplink transmission format (for example, an uplink transmission format that supports repeated transmission), an uplink transmission format corresponding to the PUCCH is also the uplink transmission format that supports repeated transmission. For another example, when a target uplink transmission format corresponding to the MsgA is the second uplink transmission format (for example, an uplink transmission format that does not support repeated transmission), an uplink transmission format corresponding to the PUCCH is also the uplink transmission format that does not support repeated transmission.

In some embodiments, a segment length corresponding to the first uplink transmission format is the same as a segment length corresponding to the second uplink transmission format.

For example, in an example in which the uplink transmission is PRACH transmission, the first PRACH format and the second PRACH format correspond to a same segment length.

In some embodiments, a segment length corresponding to the first uplink transmission format is a first segment length, and a segment length corresponding to the second uplink transmission format is a second segment length; and the first segment length and the second segment length are independently configured and/or the first segment length and the second segment length correspond to configuration parameters of different formats and/or the first segment length and the second segment length correspond to different terminal devices with different time-frequency synchronization capabilities and/or the first segment length and the second segment length correspond to different terminal devices supporting different duration of uplink transmission in which power consistency and phase continuity are maintained.

For example, in an example in which the uplink transmission is PRACH transmission, a first PRACH format corresponds to a first segment length, and a second PRACH format corresponds to a second segment length. The first segment length and the second segment length are independently configured and/or the first segment length and the second segment length correspond to PRACH configuration parameters of different formats and/or the first segment length and the second segment length correspond to different terminal devices with different time-frequency synchronization capabilities and/or the first segment length and the second segment length correspond to different terminal devices supporting different duration of uplink transmission in which power consistency and phase continuity are maintained.

In some embodiments, the first uplink transmission format and the second uplink transmission format correspond to same uplink transmission.

For example, both the first uplink transmission format and the second uplink transmission format correspond to a PRACH; or both the first uplink transmission format and the second uplink transmission format correspond to a MsgA; or both the first uplink transmission format and the second uplink transmission format correspond to a CG-PUSCH.

In some embodiments, the first uplink transmission format and the second uplink transmission format correspond to different uplink transmission.

For example, the first uplink transmission format corresponds to a PRACH, and the second uplink transmission format corresponds to a CG-PUSCH; or the first uplink transmission format corresponds to a MsgA, and the second uplink transmission format corresponds to a CG-PUSCH.

In some embodiments, uplink transmission corresponding to the first uplink transmission format and/or the second uplink transmission format is uplink transmission in an RRC idle state or an RRC inactive state; or uplink transmission corresponding to the first uplink transmission format and/or the second uplink transmission format is uplink transmission performed before dedicated RRC signalling is configured. For example, uplink transmission corresponding to the first uplink transmission format and the second uplink transmission format is uplink transmission in an initial access process.

In some embodiments, the terminal device reports a first UE capability of the terminal device to the network device. Correspondingly, the network device obtains the first UE capability of the terminal device that is reported by the terminal device, where the first UE capability is a time interval supported by the terminal device and used for time domain synchronization and/or frequency domain synchronization. Herein, optionally, the time interval includes a minimum time interval and/or a maximum time interval.

In the foregoing solution, the terminal device may explicitly or implicitly report the first UE capability of the terminal device to the network device.

Optionally, the first UE capability may be explicitly reported in the following manner: The terminal device reports the first UE capability of the terminal device to the network device through a PUSCH, and correspondingly, the network device obtains the first UE capability of the terminal device from the PUSCH sent by the terminal device, where the PUSCH carries first indication information, and the first indication information is used to indicate the first UE capability of the terminal device. Optionally, the PUSCH may be a Msg3-PUSCH.

Optionally, the first UE capability may be implicitly reported in the following manner: The terminal device reports the first UE capability of the terminal device to the network device through a target uplink transmission resource and/or the target uplink transmission format corresponding to the uplink transmission, and correspondingly, the network device obtains the first UE capability of the terminal device from the target uplink transmission resource and/or the target uplink transmission format corresponding to the uplink transmission sent by the terminal device, where different uplink transmission resources correspond to different first UE capabilities and/or different uplink transmission formats correspond to different first UE capabilities and/or different uplink transmission resource sets correspond to different first UE capabilities. Herein, the terminal device selects a corresponding target uplink transmission resource set and/or the corresponding target uplink transmission resource and/or the corresponding target uplink transmission format for the uplink transmission based on the first UE capability of the terminal device.

For example, in an example in which the uplink transmission is PRACH transmission, a first PRACH format corresponds to at least two PRACH resource sets, and the first UE capability has an association relationship with the at least two PRACH resource sets. For example, a PRACH resource set 1 is associated with a time interval 1, and a PRACH resource set 2 is associated with a time interval 2. When the terminal device supports the time interval 1, a PRACH resource is selected from the PRACH resource set 1 for transmission; and when the terminal device supports the time interval 2, a PRACH resource is selected from the PRACH resource set 2 for transmission. The network device may determine the first UE capability of the terminal device based on a PRACH resource set to which a PRACH resource of a received PRACH belongs.

For example, in an example in which the uplink transmission is PRACH transmission, the first UE capability has an association relationship with at least two PRACH formats. For example, a PRACH format 1 is associated with a time interval 1, and a PRACH format 2 is associated with a time interval 2. When the terminal device supports the time interval 1, the PRACH format 1 is selected for transmission; and when the terminal device supports the time interval 2, the PRACH format 2 is selected for transmission. The network device may determine the first UE capability of the terminal device based on a PRACH format of a received PRACH.

In some embodiments, the terminal device reports a second UE capability of the terminal device to the network device. Correspondingly, the network device obtains the second UE capability of the terminal device that is reported by the terminal device, where the second UE capability is maximum duration supported by the terminal device in which power consistency and phase continuity are maintained or whether the terminal device supports duration of uplink transmission in which power consistency and phase continuity are maintained.

In the foregoing solution, the terminal device may explicitly or implicitly report the second UE capability of the terminal device to the network device.

Optionally, the second UE capability may be explicitly reported in the following manner: The terminal device reports the second UE capability of the terminal device to the network device through a PUSCH, and correspondingly, the network device obtains the second UE capability of the terminal device based on a PUSCH sent by the terminal device, where the PUSCH carries second indication information, and the second indication information is used to indicate the second UE capability of the terminal device. Optionally, the PUSCH may be a Msg3-PUSCH.

Optionally, the first UE capability may be implicitly reported in the following manner: The terminal device reports the second UE capability of the terminal device to the network device through a target uplink transmission resource and/or the target uplink transmission format corresponding to the uplink transmission, and correspondingly, the network device obtains the second UE capability of the terminal device from the target uplink transmission resource and/or the target uplink transmission format corresponding to the uplink transmission sent by the terminal device, where different uplink transmission resources correspond to different second UE capabilities and/or different uplink transmission formats correspond to different second UE capabilities and/or different uplink transmission resource sets correspond to different second UE capabilities. Herein, the terminal device selects a corresponding target uplink transmission resource set and/or the corresponding target uplink transmission resource and/or the corresponding target uplink transmission format for the uplink transmission based on the second UE capability of the terminal device.

For example, in an example in which the uplink transmission is PRACH transmission, a first PRACH format corresponds to at least two PRACH resource sets, and the second UE capability has an association relationship with the at least two PRACH resource sets. For example, a PRACH resource set 1 is associated with maximum duration 1, and a PRACH resource set 2 is associated with maximum duration 2. When the terminal device supports the maximum duration 1, a PRACH resource is selected from the PRACH resource set 1 for transmission; and when the terminal device supports the maximum duration 2, a PRACH resource is selected from the PRACH resource set 2 for transmission. The network device may determine the second UE capability of the terminal device based on a PRACH resource set to which a PRACH resource of a received PRACH belongs.

For example, in an example in which the uplink transmission is PRACH transmission, the second UE capability has an association relationship with at least two PRACH formats. For example, a PRACH format 1 is associated with maximum duration 1, and a PRACH format 2 is associated with maximum duration 2. When the terminal device supports the maximum duration 1, the PRACH format 1 is selected for transmission; and when the terminal device supports the maximum duration 2, the PRACH format 2 is selected for transmission. The network device may determine the second UE capability of the terminal device based on a PRACH format of a received PRACH.

In the foregoing solution, the terminal device may report the first UE capability and/or the second UE capability. In some embodiments, the first segment length is associated with the first UE capability and/or the second UE capability of the terminal device, in other words, the first segment time window is determined based on the first UE capability and/or the second UE capability. Optionally, for example, the first segment length is calculated based on the first UE capability and/or the second UE capability, or the first segment length is configured by the network device based on the first UE capability and/or the second UE capability.

In the foregoing solution, when the terminal device reports the first UE capability and the second UE capability together, optionally, the PUSCH (for example, the Msg3-PUSCH) may carry the first indication information and the second indication information, where the first indication information is used to indicate the first UE capability of the terminal device, and the second indication information is used to indicate the second UE capability of the terminal device.

In the foregoing solution, when the terminal device reports the first UE capability and the second UE capability together, optionally, the first UE capability and the second UE capability of the terminal device may be reported to the network device though the target uplink transmission resource and/or the target uplink transmission format corresponding to the uplink transmission.

For example, in an example in which the uplink transmission is PRACH transmission, a first PRACH format corresponds to at least four PRACH resource sets, and the first UE capability and the second UE capability have an association relationship with the at least four PRACH resource sets. For example, a PRACH resource set 1 is associated with a time interval 1 and maximum duration 1, a PRACH resource set 2 is associated with the time interval 1 and maximum duration 2, a PRACH resource set 3 is associated with a time interval 2 and the maximum duration 1, and a PRACH resource set 4 is associated with the time interval 2 and the maximum duration 2. When the terminal device supports the time interval 1 and the maximum duration 1, a PRACH resource is selected from the PRACH resource set 1 for transmission; when the terminal device supports the time interval 1 and the maximum duration 2, a PRACH resource is selected from the PRACH resource set 2 for transmission; when the terminal device supports the time interval 2 and the maximum duration 1, a PRACH resource is selected from the PRACH resource set 3 for transmission; and when the terminal device supports the time interval 2 and the maximum duration 2, a PRACH resource is selected from the PRACH resource set 4 for transmission. The network device may determine the first UE capability and the second UE capability of the terminal device based on a PRACH resource set to which a PRACH resource of a received PRACH belongs.

For example, in an example in which the uplink transmission is PRACH transmission, the first UE capability and the second UE capability have an association relationship with at least four PRACH formats. For example, a PRACH format 1 is associated with a time interval 1 and maximum duration 1, a PRACH format 2 is associated with the time interval 1 and maximum duration 2, a PRACH format 3 is associated with a time interval 2 and the maximum duration 1, and a PRACH format 4 is associated with the time interval 2 and the maximum duration 2. When the terminal device supports the time interval 1 and the maximum duration 1, the PRACH format 1 is selected for transmission; when the terminal device supports the time interval 1 and the maximum duration 2, the PRACH format 2 is selected for transmission; when the terminal device supports the time interval 2 and the maximum duration 1, the PRACH format 3 is selected for transmission; and when the terminal device supports the time interval 2 and the maximum duration 2, the PRACH format 4 is selected for transmission. The network device may determine the first UE capability and the second UE capability of the terminal device based on a PRACH format of a received PRACH.

In some embodiments, the network device may obtain the first UE capability and/or the second UE capability reported by the terminal device, configure the first segment length based on the first UE capability and/or the second UE capability, and send configuration information of the first segment length to the terminal device.

In some embodiments, a configuration parameter of at least a part of the at least one uplink transmission format is used to determine a first RO set; and in the first RO set, an association rule among a preamble, an RO, and an SSB includes at least one of the following:
each RO is associated with N SSBs, each SSB corresponds to R preambles used for contention access, N is a positive integer or 1/N is a positive integer, and R is a positive integer; and
an arrangement order of preambles, ROs, and SSBs is as follows: first, preambles are arranged in an ascending order of preamble indexes within each RO, second, ROs for frequency division multiplexing are arranged in an ascending order of frequency domain resource indexes, and finally, ROs for time division multiplexing are arranged in an ascending order of time domain resource indexes; or first, ROs for frequency division multiplexing are arranged in an ascending order of frequency domain resource indexes, and second, ROs for time division multiplexing are arranged in an ascending order of time domain resource indexes.

Optionally, a configuration parameter of an uplink transmission format in the at least one uplink transmission format is used to determine a first RO set. For example, a configuration parameter of the first uplink transmission format in the at least one uplink transmission format is used to determine the first RO set.

Optionally, configuration parameters of at least two uplink transmission formats in the at least one uplink transmission format are used to determine the first RO set. For example, configuration parameters of the first uplink transmission format and the second uplink transmission format in the at least one uplink transmission format are used to determine the first RO set. For another example, configuration parameters of all uplink transmission formats in the at least one uplink transmission format are used to determine the first RO set.

For example, in an example in which the uplink transmission is PRACH transmission, an association rule among a preamble, an RO, and an SSB is as follows:

(I) In the first RO set, each RO is associated with N SSBs, each SSB corresponds to R preambles used for contention access, N is a positive integer or 1/N is a positive integer, and R is a positive integer.

When N<1, one SSB is associated with a plurality of (that is, 1/N) ROs.

When N=1, one SSB is associated with one RO.

When N>1, a plurality of SSBs (that is, N SSBs) are associated with one RO.

(II) Preambles corresponding to each SSB may be divided into a group A and a group B.

(III) There are N*R preambles used for contention access in total.

(IV) An arrangement order of preambles, ROs, and SSBs is as follows:

Case 1: In the first RO set, preambles are arranged in an ascending order of preamble indexes within each RO, second, ROs for frequency division multiplexing are arranged in an ascending order of frequency domain resource indexes, and finally, ROs for time division multiplexing are arranged in an ascending order of time domain resource indexes. Based on this arrangement order and with reference to values of the foregoing parameters N and R, an association relationship between an SSB and an RO and/or a preamble may be determined. Herein, that ROs for time division multiplexing are arranged in an ascending order of time domain resource indexes may further include: time domain resource indexes of ROs for time domain multiplexing in each PRACH slot are arranged in an ascending order; and PRACH slot indexes are arranged in an ascending order.

Case 2: In the first RO set, in a case that a PDCCH order indicates a preamble index and a preamble mask index, first, ROs for frequency division multiplexing are arranged in an ascending order of frequency domain resource indexes, and second, ROs for time division multiplexing are arranged in an ascending order of time domain resource indexes. Based on this arrangement order and with reference to values of the foregoing parameters N and R, an association relationship between an SSB and an RO and/or a preamble may be determined. Herein, that ROs for time division multiplexing are arranged in an ascending order of time domain resource indexes may further include: time domain resource indexes of ROs for time domain multiplexing in each PRACH slot are arranged in an ascending order; and PRACH slot indexes are arranged in an ascending order.

In the technical solutions of embodiments of this application, by introducing the new uplink transmission format, the terminal device can achieve uplink coverage enhancement when performing uplink transmission, so that the terminal device can smoothly perform the uplink transmission.

The foregoing describes in detail the preferred implementations of this application with reference to the accompanying drawings. However, this application is not limited to specific details of the foregoing implementations. Within a technical concept scope of this application, a plurality of simple variations of the technical solutions of this application may be performed, and these simple variations are all within the protection scope of this application. For example, each specific technical feature described in the foregoing specific implementations may be combined in any suitable manner without contradiction. To avoid unnecessary repetition, various possible combination manners are not described otherwise in this application. For another example, any combination may also be performed between different implementations of this application, provided that the combination is not contrary to the idea of this application, the combination shall also be considered as the content disclosed in this application. For another example, without a conflict, the embodiments and/or the technical features in the embodiments described in this application may be randomly combined with the prior art, and the technical solutions obtained after the combination also fall within the protection scope of this application.

It should be further understood that, in the method embodiments of this application, sequence numbers of the foregoing processes do not mean execution sequences. The execution sequences of the processes shall be determined according to functions and internal logic of the processes, and shall not be construed as any limitation on the implementation processes of embodiments of this application. In addition, in embodiments of this application, the terms “downlink”, “uplink”, and “sidelink” are used to indicate a transmission direction of a signal or data, where “downlink” indicates that a transmission direction of a signal or data is a first direction from a station to user equipment in a cell, “uplink” indicates that a transmission direction of a signal or data is a second direction from user equipment in a cell to a station, and “sidelink” indicates that a transmission direction of a signal or data is a third direction from user equipment 1 to user equipment 2. For example, a “downlink signal” indicates that a transmission direction of the signal is the first direction. In addition, in embodiments of this application, the term “and/or” is merely used to describe an association relationship between associated objects, and represents that there may be three relationships. Specifically, A and/or B may represent three cases: only A exists, both A and B exist, and only B exists. In addition, the character “/” in this specification generally indicates an “or” relationship between the associated objects.

FIG. 7 is a schematic structural diagram of an uplink transmission apparatus according to an embodiment of this application, applied to a terminal device. As shown in FIG. 7, the uplink transmission apparatus includes:
a receiving unit 701, configured to receive first configuration information sent by a network device, where the first configuration information is used to determine at least one uplink transmission format, the at least one uplink transmission format includes a first uplink transmission format, and the first uplink transmission format is different from a basic transmission format;
a processing unit 702, configured to determine a target uplink transmission format from the at least one uplink transmission format; and
a sending unit 703, configured to send uplink transmission based on the target uplink transmission format.

In some embodiments, the first configuration information is used to determine a configuration parameter of the at least one uplink transmission format, and the processing unit 702 is configured to determine the configuration parameter of the at least one uplink transmission format based on the first configuration information.

In some embodiments, a quantity of configuration parameters is configured in the first configuration information, or is predefined.

In some embodiments, a configuration parameter of at least a part of the at least one uplink transmission format is used to determine a first RO set; and in the first RO set, an association rule among a preamble, an RO, and an SSB includes at least one of the following:
each RO is associated with N SSBs, each SSB corresponds to R preambles used for contention access, N is a positive integer or 1/N is a positive integer, and R is a positive integer; and
an arrangement order of preambles, ROs, and SSBs is as follows: first, preambles are arranged in an ascending order of preamble indexes within each RO, second, ROs for frequency division multiplexing are arranged in an ascending order of frequency domain resource indexes, and finally, ROs for time division multiplexing are arranged in an ascending order of time domain resource indexes; or first, ROs for frequency division multiplexing are arranged in an ascending order of frequency domain resource indexes, and second, ROs for time division multiplexing are arranged in an ascending order of time domain resource indexes.

In some embodiments, the first uplink transmission format corresponds to a first segment length, and the first segment length is used to determine a first segment time window. The processing unit 702 is configured to: before the uplink transmission is sent by using the first segment time window, perform time domain synchronization adjustment and/or frequency domain synchronization adjustment on the uplink transmission to be transmitted within the first segment time window.

In some embodiments, the first segment length is predefined, or is determined based on a predefined rule, or is configured in the first configuration information.

In some embodiments, the first segment length is associated with a first UE capability of the terminal device, and the first UE capability is a time interval supported by the terminal device and used for time domain synchronization and/or frequency domain synchronization.

In some embodiments, the sending unit 703 is configured to report the first UE capability of the terminal device to the network device.

In some embodiments, the sending unit 703 is configured to report the first UE capability of the terminal device to the network device through a PUSCH, where the PUSCH carries first indication information, and the first indication information is used to indicate the first UE capability of the terminal device.

In some embodiments, the sending unit 703 is configured to report the first UE capability of the terminal device to the network device through a target uplink transmission resource and/or the target uplink transmission format corresponding to the uplink transmission,
where different uplink transmission resources correspond to different first UE capabilities and/or different uplink transmission formats correspond to different first UE capabilities and/or different uplink transmission resource sets correspond to different first UE capabilities.

In some embodiments, the processing unit 702 is configured to select a corresponding target uplink transmission resource set and/or the corresponding target uplink transmission resource and/or the corresponding target uplink transmission format for the uplink transmission based on the first UE capability of the terminal device.

In some embodiments, the first segment time window is determined based on at least two of a transmission start time, a transmission end time, and transmission duration of the uplink transmission.

In some embodiments, the first segment time window is determined based on an effective transmission time of the uplink transmission.

In some embodiments, the processing unit 702 is configured to perform the time domain synchronization adjustment and/or frequency domain synchronization adjustment based on at least one of a location of the terminal device, a common timing parameter configured by the network device, and service satellite ephemeris information configured by the network device.

In some embodiments, the sending unit 703 is configured to report a second UE capability of the terminal device to the network device, where the second UE capability is maximum duration supported by the terminal device in which power consistency and phase continuity are maintained or whether the terminal device supports duration of uplink transmission in which power consistency and phase continuity are maintained.

In some embodiments, the sending unit 703 is configured to report the second UE capability of the terminal device to the network device through a PUSCH, where the PUSCH carries second indication information, and the second indication information is used to indicate the second UE capability of the terminal device.

In some embodiments, the sending unit 703 is configured to report the second UE capability of the terminal device to the network device through a target uplink transmission resource and/or the target uplink transmission format corresponding to the uplink transmission,
where different uplink transmission resources correspond to different second UE capabilities and/or different uplink transmission formats correspond to different second UE capabilities and/or different uplink transmission resource sets correspond to different second UE capabilities.

In some embodiments, the processing unit 702 is configured to select a corresponding target uplink transmission resource set and/or the corresponding target uplink transmission resource and/or the corresponding target uplink transmission format for the uplink transmission based on the second UE capability of the terminal device.

In some embodiments, uplink transmission corresponding to the first uplink transmission format is P times of repeated uplink transmission corresponding to the basic transmission format, and P is a positive integer.

In some embodiments, the at least one uplink transmission format further includes a second uplink transmission format, and the second uplink transmission format is the same as the basic transmission format or the second uplink transmission format is different from the basic transmission format.

In some embodiments, uplink transmission corresponding to the first uplink transmission format is M times of repeated uplink transmission corresponding to the second uplink transmission format, and M is an integer greater than or equal to 2.

In some embodiments, a value of M is configured in the first configuration information, or is predefined, or is determined based on a value set of M configured in the first configuration information.

In some embodiments, uplink transmission corresponding to the first uplink transmission format is P times of repeated uplink transmission corresponding to the basic transmission format, uplink transmission corresponding to the second uplink transmission format is Q times of repeated uplink transmission corresponding to the basic transmission format, P and Q are both positive integers, and values of P and Q are different.

In some embodiments, a value of P is configured in the first configuration information, or is predefined, or is determined based on a value set of P configured in the first configuration information.

In some embodiments, a value of Q is configured in the first configuration information, or is predefined, or is determined based on a value set of Q configured in the first configuration information.

In some embodiments, the uplink transmission is PRACH transmission or MsgA transmission; and an RAR format corresponding to the first uplink transmission format is the same as an RAR format corresponding to the second uplink transmission format.

In some embodiments, the uplink transmission is PRACH transmission; and an RAR format corresponding to the first uplink transmission format is a first RAR format, an RAR format corresponding to the second uplink transmission format is a second RAR format, and the first RAR format is different from the second RAR format and/or an information field in an uplink grant included in the first RAR format is different from an information field in an uplink grant included in the second RAR format and/or a PUCCH resource configuration corresponding to the first RAR format is different from a PUCCH resource configuration corresponding to the second RAR format.

In some embodiments, the uplink transmission is MsgA transmission; and an RAR format corresponding to the first uplink transmission format is a first RAR format, an RAR format corresponding to the second uplink transmission format is a second RAR format, and the first RAR format is different from the second RAR format and/or a PUCCH resource configuration corresponding to the first RAR format is different from a PUCCH resource configuration corresponding to the second RAR format.

In some embodiments, the uplink transmission is PRACH transmission; and a number of times of repeated Msg3-PUSCH transmission corresponding to the first uplink transmission format is different from a number of times of repeated Msg3-PUSCH transmission corresponding to the second uplink transmission format; or a number of times of repeated Msg3-PUSCH transmission corresponding to the first uplink transmission format is the same as a number of times of repeated Msg3-PUSCH transmission corresponding to the second uplink transmission format.

In some embodiments, the uplink transmission is PRACH transmission; and a configuration set of a number of times of repeated Msg3-PUSCH transmission corresponding to the first uplink transmission format is different from a configuration set of a number of times of repeated Msg3-PUSCH transmission corresponding to the second uplink transmission format; or
a configuration set of a number of times of repeated Msg3-PUSCH transmission corresponding to the first uplink transmission format is the same as a configuration set of a number of times of repeated Msg3-PUSCH transmission corresponding to the second uplink transmission format, where the configuration set of the number of times of repeated Msg3-PUSCH transmission is used to determine the number of times of repeated Msg3-PUSCH transmission.

In some embodiments, a segment length corresponding to the first uplink transmission format is the same as a segment length corresponding to the second uplink transmission format.

In some embodiments, a segment length corresponding to the first uplink transmission format is a first segment length, and a segment length corresponding to the second uplink transmission format is a second segment length; and the first segment length and the second segment length are independently configured and/or the first segment length and the second segment length correspond to configuration parameters of different formats and/or the first segment length and the second segment length correspond to different terminal devices with different time-frequency synchronization capabilities and/or the first segment length and the second segment length correspond to different terminal devices supporting different duration of uplink transmission in which power consistency and phase continuity are maintained.

In some embodiments, the first uplink transmission format and the second uplink transmission format correspond to same uplink transmission; or the first uplink transmission format and the second uplink transmission format correspond to different uplink transmission.

In some embodiments, uplink transmission corresponding to the first uplink transmission format and/or the second uplink transmission format is uplink transmission in an RRC idle state or an RRC inactive state; or uplink transmission corresponding to the first uplink transmission format and/or the second uplink transmission format is uplink transmission performed before dedicated RRC signalling is configured.

In some embodiments, the second uplink transmission format includes one or more transmission formats.

In some embodiments, the first uplink transmission format includes one or more transmission formats; and/or the basic transmission format includes one or more transmission formats.

In some embodiments, the processing unit 702 is configured to: determine the target uplink transmission format from the at least one uplink transmission format independently; or determine the target uplink transmission format from the at least one uplink transmission format based on an indication from the network device.

In some embodiments, the processing unit 702 is configured to determine the target uplink transmission format from the at least one uplink transmission format based on measured signal strength.

In some embodiments, the processing unit 702 is configured to: determine, based on at least one signal strength threshold, a signal strength range to which the measured signal strength belongs, and determine the target uplink transmission format from the at least one uplink transmission format based on the signal strength range to which the signal strength belongs.

In some embodiments, the at least one signal strength threshold is used to determine at least two signal strength ranges, and each of the at least two signal strength ranges corresponds to a respective uplink transmission format.

In some embodiments, the at least one signal strength threshold is configured in the first configuration information, or is predefined, or is determined based on a value set of a signal strength threshold configured in the first configuration information.

In some embodiments, the processing unit 702 is configured to: determine the target uplink transmission format from the at least one uplink transmission format based on downlink control information sent by the network device, where the downlink control information is used to indicate the target uplink transmission format; or determine the target uplink transmission format from the at least one uplink transmission format based on a PDCCH order sent by the network device, where the uplink transmission is PRACH transmission, and the PDCCH order is used to indicate a target PRACH transmission format corresponding to the PRACH transmission.

In some embodiments, the first configuration information is configured by using at least one of the following signalling: system information, RRC signalling, a MAC CE, or DCI.

A person skilled in the art should understand that related descriptions of the foregoing uplink transmission apparatus in embodiments of this application may be understood with reference to the related descriptions of the uplink transmission method in embodiments of this application.

FIG. 8 is a schematic structural diagram of another uplink transmission apparatus according to an embodiment of this application, applied to a network device. As shown in FIG. 8, the uplink transmission apparatus includes:
a sending unit 801, configured to send first configuration information to a terminal device, where the first configuration information is used to determine at least one uplink transmission format, the at least one uplink transmission format includes a first uplink transmission format, and the first uplink transmission format is different from a basic transmission format; and
a receiving unit 802, configured to receive uplink transmission sent by the terminal device based on a target uplink transmission format, where the target uplink transmission format is determined from the at least one uplink transmission format.

In some embodiments, the first configuration information is used to determine a configuration parameter of the at least one uplink transmission format.

In some embodiments, a quantity of configuration parameters is configured in the first configuration information, or is predefined.

In some embodiments, a configuration parameter of at least a part of the at least one uplink transmission format is used to determine a first RO set; and in the first RO set, an association rule among a preamble, an RO, and an SSB includes at least one of the following:
each RO is associated with N SSBs, each SSB corresponds to R preambles used for contention access, N is a positive integer or 1/N is a positive integer, and R is a positive integer; and
an arrangement order of preambles, ROs, and SSBs is as follows: first, preambles are arranged in an ascending order of preamble indexes within each RO, second, ROs for frequency division multiplexing are arranged in an ascending order of frequency domain resource indexes, and finally, ROs for time division multiplexing are arranged in an ascending order of time domain resource indexes; or first, ROs for frequency division multiplexing are arranged in an ascending order of frequency domain resource indexes, and second, ROs for time division multiplexing are arranged in an ascending order of time domain resource indexes.

In some embodiments, the first uplink transmission format corresponds to a first segment length, and the first segment length is used to determine a first segment time window.

In some embodiments, the first segment length is predefined, or is determined based on a predefined rule, or is configured in the first configuration information.

In some embodiments, the first segment length is associated with a first UE capability of the terminal device, and the first UE capability is a time interval supported by the terminal device and used for time domain synchronization and/or frequency domain synchronization.

In some embodiments, the receiving unit 802 is configured to obtain the first UE capability of the terminal device that is reported by the terminal device.

In some embodiments, the receiving unit 802 is configured to obtain the first UE capability of the terminal device based on a PUSCH sent by the terminal device, where the PUSCH carries first indication information, and the first indication information is used to indicate the first UE capability of the terminal device.

In some embodiments, the receiving unit 802 is configured to obtain the first UE capability of the terminal device based on a target uplink transmission resource and/or the target uplink transmission format corresponding to the uplink transmission sent by the terminal device,
where different uplink transmission resources correspond to different first UE capabilities and/or different uplink transmission formats correspond to different first UE capabilities and/or different uplink transmission resource sets correspond to different first UE capabilities.

In some embodiments, the first segment time window is determined based on at least two of a transmission start time, a transmission end time, and transmission duration of the uplink transmission.

In some embodiments, the first segment time window is determined based on an effective transmission time of the uplink transmission.

In some embodiments, the receiving unit 802 is configured to obtain a second UE capability of the terminal device that is reported by the terminal device, where the second UE capability is maximum duration supported by the terminal device in which power consistency and phase continuity are maintained or whether the terminal device supports duration of uplink transmission in which power consistency and phase continuity are maintained.

In some embodiments, the receiving unit 802 is configured to obtain the second UE capability of the terminal device based on a PUSCH sent by the terminal device, where the PUSCH carries second indication information, and the second indication information is used to indicate the second UE capability of the terminal device.

In some embodiments, the receiving unit 802 is configured to obtain the second UE capability of the terminal device based on a target uplink transmission resource and/or the target uplink transmission format corresponding to the uplink transmission sent by the terminal device,
where different uplink transmission resources correspond to different second UE capabilities and/or different uplink transmission formats correspond to different second UE capabilities and/or different uplink transmission resource sets correspond to different second UE capabilities.

In some embodiments, uplink transmission corresponding to the first uplink transmission format is P times of repeated uplink transmission corresponding to the basic transmission format, and P is a positive integer.

In some embodiments, the at least one uplink transmission format further includes a second uplink transmission format, and the second uplink transmission format is the same as the basic transmission format or the second uplink transmission format is different from the basic transmission format.

In some embodiments, uplink transmission corresponding to the first uplink transmission format is M times of repeated uplink transmission corresponding to the second uplink transmission format, and M is an integer greater than or equal to 2.

In some embodiments, a value of M is configured in the first configuration information, or is predefined, or is determined based on a value set of M configured in the first configuration information.

In some embodiments, uplink transmission corresponding to the first uplink transmission format is P times of repeated uplink transmission corresponding to the basic transmission format, uplink transmission corresponding to the second uplink transmission format is Q times of repeated uplink transmission corresponding to the basic transmission format, P and Q are both positive integers, and values of P and Q are different.

In some embodiments, a value of P is configured in the first configuration information, or is predefined, or is determined based on a value set of P configured in the first configuration information.

In some embodiments, a value of Q is configured in the first configuration information, or is predefined, or is determined based on a value set of Q configured in the first configuration information.

In some embodiments, the uplink transmission is PRACH transmission or MsgA transmission; and an RAR format corresponding to the first uplink transmission format is the same as an RAR format corresponding to the second uplink transmission format.

In some embodiments, the uplink transmission is PRACH transmission; and an RAR format corresponding to the first uplink transmission format is a first RAR format, an RAR format corresponding to the second uplink transmission format is a second RAR format, and the first RAR format is different from the second RAR format and/or an information field in an uplink grant included in the first RAR format is different from an information field in an uplink grant included in the second RAR format and/or a PUCCH resource configuration corresponding to the first RAR format is different from a PUCCH resource configuration corresponding to the second RAR format.

In some embodiments, the uplink transmission is MsgA transmission; and an RAR format corresponding to the first uplink transmission format is a first RAR format, an RAR format corresponding to the second uplink transmission format is a second RAR format, and the first RAR format is different from the second RAR format and/or a PUCCH resource configuration corresponding to the first RAR format is different from a PUCCH resource configuration corresponding to the second RAR format.

In some embodiments, the uplink transmission is PRACH transmission; and a number of times of repeated Msg3-PUSCH transmission corresponding to the first uplink transmission format is different from a number of times of repeated Msg3-PUSCH transmission corresponding to the second uplink transmission format; or a number of times of repeated Msg3-PUSCH transmission corresponding to the first uplink transmission format is the same as a number of times of repeated Msg3-PUSCH transmission corresponding to the second uplink transmission format.

In some embodiments, the uplink transmission is PRACH transmission; and a configuration set of a number of times of repeated Msg3-PUSCH transmission corresponding to the first uplink transmission format is different from a configuration set of a number of times of repeated Msg3-PUSCH transmission corresponding to the second uplink transmission format; or a configuration set of a number of times of repeated Msg3-PUSCH transmission corresponding to the first uplink transmission format is the same as a configuration set of a number of times of repeated Msg3-PUSCH transmission corresponding to the second uplink transmission format, where the configuration set of the number of times of repeated Msg3-PUSCH transmission is used to determine the number of times of repeated Msg3-PUSCH transmission.

In some embodiments, a segment length corresponding to the first uplink transmission format is the same as a segment length corresponding to the second uplink transmission format.

In some embodiments, a segment length corresponding to the first uplink transmission format is a first segment length, and a segment length corresponding to the second uplink transmission format is a second segment length; and the first segment length and the second segment length are independently configured and/or the first segment length and the second segment length correspond to configuration parameters of different formats and/or the first segment length and the second segment length correspond to different terminal devices with different time-frequency synchronization capabilities and/or the first segment length and the second segment length correspond to different terminal devices supporting different duration of uplink transmission in which power consistency and phase continuity are maintained.

In some embodiments, the first uplink transmission format and the second uplink transmission format correspond to same uplink transmission; or the first uplink transmission format and the second uplink transmission format correspond to different uplink transmission.

In some embodiments, uplink transmission corresponding to the first uplink transmission format and/or the second uplink transmission format is uplink transmission in an RRC idle state or an RRC inactive state; or uplink transmission corresponding to the first uplink transmission format and/or the second uplink transmission format is uplink transmission performed before dedicated RRC signalling is configured.

In some embodiments, the second uplink transmission format includes one or more transmission formats.

In some embodiments, the first uplink transmission format includes one or more transmission formats; and/or the basic transmission format includes one or more transmission formats.

In some embodiments, the sending unit 801 is configured to indicate the target uplink transmission format to the terminal device.

In some embodiments, the sending unit 801 is configured to: send downlink control information to the terminal device, where the downlink control information is used to indicate the target uplink transmission format; or send a PDCCH order to the terminal device, where the uplink transmission is PRACH transmission, and the PDCCH order is used to indicate a target PRACH transmission format corresponding to the PRACH transmission.

In some embodiments, the first configuration information is configured by using at least one of the following signalling: system information, RRC, a MAC CE, or DCI.

A person skilled in the art should understand that related descriptions of the foregoing uplink transmission apparatus in embodiments of this application may be understood with reference to the related descriptions of the uplink transmission method in embodiments of this application.

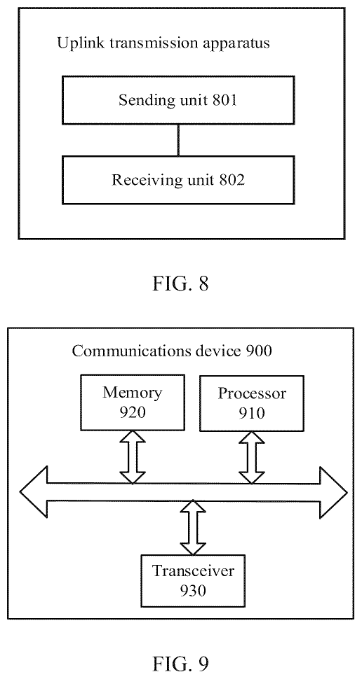

FIG. 9 is a schematic structural diagram of a communications device 900 according to an embodiment of this application. The communications device may be a terminal device, or may be a network device. The communications device 900 shown in FIG. 9 includes a processor 910, and the processor 910 may invoke and run a computer program in a memory to implement a method in embodiments of this application.

Optionally, as shown in FIG. 9, the communications device 900 may further include a memory 920. The processor 910 may invoke and run a computer program in the memory 920 to implement a method in embodiments of this application.

The memory 920 may be a separate component independent of the processor 910, or may be integrated into the processor 910.

Optionally, as shown in FIG. 9, the communications device 900 may further include a transceiver 930. The processor 910 may control the transceiver 930 to communicate with another device, and specifically, may send information or data to the another device, or receive information or data sent by the another device.

The transceiver 930 may include a transmitter and a receiver. The transceiver 930 may further include an antenna, and there may be one or more antennas.

Optionally, the communications device 900 may be specifically the network device in embodiments of this application, and the communications device 900 may implement corresponding processes implemented by the network device in methods in embodiments of this application. For brevity, details are not described herein again.

Optionally, the communications device 900 may be specifically the mobile terminal/terminal device in embodiments of this application, and the communications device 900 may implement corresponding processes implemented by the mobile terminal/terminal device in methods in embodiments of this application. For brevity, details are not described herein again.

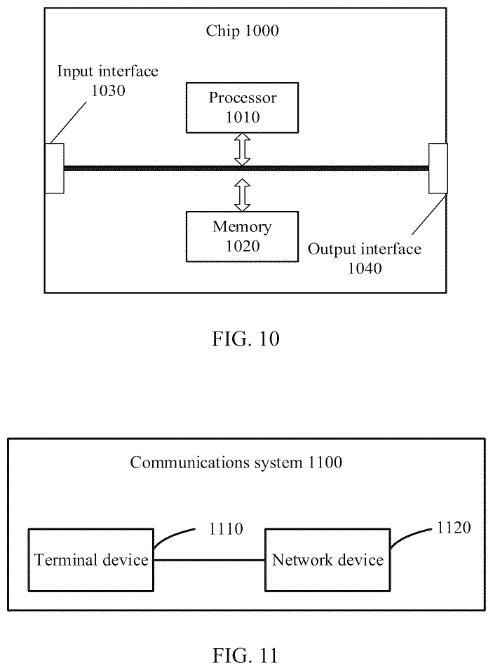

FIG. 10 is a schematic structural diagram of a chip according to an embodiment of this application. The chip 1000 shown in FIG. 10 includes a processor 1010, and the processor 1010 may invoke and run a computer program in a memory to implement a method in embodiments of this application.

Optionally, as shown in FIG. 10, the chip 1000 may further include a memory 1020. The processor 1010 may invoke and run a computer program in the memory 1020 to implement a method in embodiments of this application.

The memory 1020 may be a separate component independent of the processor 1010, or may be integrated into the processor 1010.

Optionally, the chip 1000 may further include an input interface 1030. The processor 1010 may control the input interface 1030 to communicate with another device or chip, and specifically, may obtain information or data sent by the another device or chip.

Optionally, the chip 1000 may further include an output interface 1040. The processor 1010 may control the output interface 1040 to communicate with another device or chip, and specifically, may output information or data to the another device or chip.

Optionally, the chip may be applied to the network device in embodiments of this application, and the chip may implement corresponding processes implemented by the network device in methods in embodiments of this application. For brevity, details are not described herein again.

Optionally, the chip may be applied to the mobile terminal/terminal device in embodiments of this application, and the chip may implement corresponding processes implemented by the mobile terminal/terminal device in methods in embodiments of this application. For brevity, details are not described herein again.

It should be understood that the chip mentioned in this embodiment of this application may also be referred to as a system-level chip, a system chip, a chip system, or a system-on-chip.

FIG. 11 is a schematic block diagram of a communications system 1100 according to an embodiment of this application. As shown in FIG. 11, the communications system 1100 includes a terminal device 1110 and a network device 1120.

The terminal device 1110 may be configured to implement corresponding functions implemented by the terminal device in the foregoing method, and the network device 1120 may be configured to implement corresponding functions implemented by the network device in the foregoing method. For brevity, details are not described herein again.

It should be understood that, a processor in embodiments of this application may be an integrated circuit chip having a signal processing capability. In an implementation process, the steps in the foregoing method embodiments may be performed by using an integrated logic circuit of hardware of the processor or instructions in a software form. The processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor can implement or perform the methods, steps and logical block diagrams disclosed in embodiments of this application. The general-purpose processor may be a microprocessor, or the processor may be any conventional processor or the like. The steps of the methods disclosed with reference to embodiments of this application may be directly implemented by a hardware decoding processor, or may be implemented by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), and is used as an external cache. By way of example but not limitative description, many forms of RAMs may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DR RAM). It should be noted that, the memory in the systems and methods described in this specification includes but is not limited to these memories and any memory of another proper type.

It should be understood that, by way of example but not limitative description, for example, the memory in embodiments of this application may alternatively be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synch link DRAM, SLDRAM), a direct rambus random access memory (Direct Rambus RAM, DR RAM), or the like. In other words, the memory in this embodiment of this application includes but is not limited to these memories and any memory of another proper type.

An embodiment of this application further provides a computer-readable storage medium, configured to store a computer program.

Optionally, the computer-readable storage medium may be applied to the network device in embodiments of this application, and the computer program causes a computer to execute corresponding processes implemented by the network device in methods in embodiments of this application. For brevity, details are not described herein again.

Optionally, the computer-readable storage medium may be applied to the mobile terminal/terminal device in embodiments of this application, and the computer program causes a computer to execute corresponding processes implemented by the mobile terminal/terminal device in methods in embodiments of this application. For brevity, details are not described herein again.

An embodiment of this application further provides a computer program product, including computer program instructions.

Optionally, the computer program product may be applied to the network device in embodiments of this application, and the computer program instructions cause a computer to execute corresponding processes implemented by the network device in methods in embodiments of this application. For brevity, details are not described herein again.

Optionally, the computer program product may be applied to the mobile terminal/terminal device in embodiments of this application, and the computer program instructions cause a computer to execute corresponding processes implemented by the mobile terminal/terminal device in methods in embodiments of this application. For brevity, details are not described herein again.

An embodiment of this application further provides a computer program.

Optionally, the computer program may be applied to the network device in embodiments of this application, and when run on a computer, the computer program causes the computer to execute corresponding processes implemented by the network device in methods in embodiments of this application. For brevity, details are not described herein again.

Optionally, the computer program may be applied to the mobile terminal/terminal device in embodiments of this application, and when run on a computer, the computer program causes the computer to execute corresponding processes implemented by the mobile terminal/terminal device in methods in embodiments of this application. For brevity, details are not described herein again.

A person of ordinary skill in the art may be aware that, units and algorithm steps in examples described in combination with embodiments disclosed in this specification can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

Those skilled in the art that may clearly understand that, for the purpose of convenient and brief description, for detailed working processes of the foregoing system, apparatus, and unit, reference may be made to a corresponding procedure in the foregoing method embodiments, and details are not described herein again.

In several embodiments provided in this application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented by using some interfaces. The indirect couplings or communication connections between the apparatuses or units may be implemented in electronic, mechanical, or other forms.

Units described as separate components may be or may not be physically separate, and components displayed as units may be or may not be physical units, that is, may be located in one place or distributed on a plurality of network units. Some or all of the units may be selected according to actual requirements to achieve the objective of the solutions of embodiments.

In addition, function units in embodiments of this application may be integrated into one processing unit, or each of the units may exist alone physically, or two or more units may be integrated into one unit.

When the functions are implemented in a form of a software function unit and sold or used as an independent product, the functions may be stored in a computer-readable storage medium. Based on such an understanding, the technical solutions in embodiments of this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to execute all or some of the steps of the methods in embodiments of this application. The foregoing storage medium includes any medium that can store program code, such as a USB flash drive, a removable hard disk, a read-only memory (ROM), a random access memory (RAM), a magnetic disk, or an optical disk.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application should be subject to the protection scope of the claims.

What is claimed is:

1. An uplink transmission method, wherein the method comprises:
receiving, by a terminal device, first configuration information sent by a network device, wherein the first configuration information is used to determine at least one uplink transmission format, the at least one uplink transmission format comprises a first uplink transmission format, and the first uplink transmission format is different from a basic transmission format; and
determining, by the terminal device, a target uplink transmission format from the at least one uplink transmission format, and sending uplink transmission based on the target uplink transmission format.

2. A terminal device, comprising a processor configured to perform operations of:
receiving first configuration information sent by a network device, wherein the first configuration information is used to determine at least one uplink transmission format, the at least one uplink transmission format comprises a first uplink transmission format, and the first uplink transmission format is different from a basic transmission format; and
determining a target uplink transmission format from the at least one uplink transmission format, and sending uplink transmission based on the target uplink transmission format.

3. The terminal device according to claim 2, wherein the first configuration information is used to determine a configuration parameter of the at least one uplink transmission format, and the processor is further configured to perform an operation of:
determining the configuration parameter of the at least one uplink transmission format based on the first configuration information.

4. The terminal device according to claim 3, wherein a quantity of configuration parameters is configured in the first configuration information, or is predefined.

5. The terminal device according to claim 3, wherein a configuration parameter of at least a part of the at least one uplink transmission format is used to determine a first random access channel transmission occasion (RO) set; and in the first RO set, an association rule among a preamble, an RO, and a synchronization signal and physical broadcast channel block (SSB) comprises at least one of the following:
each RO is associated with N SSBs, each SSB corresponds to R preambles used for contention access, N is a positive integer or 1/N is a positive integer, and R is a positive integer; and
an arrangement order of preambles, ROs, and SSBs is as follows: first, preambles are arranged in an ascending order of preamble indexes within each RO, second, ROs for frequency division multiplexing are arranged in an ascending order of frequency domain resource indexes, and finally, ROs for time division multiplexing are arranged in an ascending order of time domain resource indexes; or first, ROs for frequency division multiplexing are arranged in an ascending order of frequency domain resource indexes, and second, ROs for time division multiplexing are arranged in an ascending order of time domain resource indexes.

6. The terminal device according to claim 2, wherein the at least one uplink transmission format further comprises a second uplink transmission format, and the second uplink transmission format is the same as the basic transmission format or the second uplink transmission format is different from the basic transmission format.

7. The terminal device according to claim 6, wherein the uplink transmission is physical random access channel (PRACH) transmission or message A (MsgA) transmission; and
a random access response RAR format corresponding to the first uplink transmission format is the same as an RAR format corresponding to the second uplink transmission format.

8. The terminal device according to claim 6, wherein the uplink transmission is PRACH transmission; and
an RAR format corresponding to the first uplink transmission format is a first RAR format, an RAR format corresponding to the second uplink transmission format is a second RAR format, and the first RAR format is different from the second RAR format and/or an information field in an uplink grant comprised in the first RAR format is different from an information field in an uplink grant comprised in the second RAR format and/or a physical uplink control channel PUCCH resource configuration corresponding to the first RAR format is different from a PUCCH resource configuration corresponding to the second RAR format.

9. The terminal device according to claim 6, wherein the uplink transmission is MsgA transmission; and
an RAR format corresponding to the first uplink transmission format is a first RAR format, an RAR format corresponding to the second uplink transmission format is a second RAR format, and the first RAR format is different from the second RAR format and/or a PUCCH resource configuration corresponding to the first RAR format is different from a PUCCH resource configuration corresponding to the second RAR format.

10. The terminal device according to claim 6, wherein the uplink transmission is PRACH transmission; and
a configuration set of a number of times of repeated Msg3-PUSCH transmission corresponding to the first uplink transmission format is different from a configuration set of a number of times of repeated Msg3-PUSCH transmission corresponding to the second uplink transmission format; or
a configuration set of a number of times of repeated Msg3-PUSCH transmission corresponding to the first uplink transmission format is the same as a configuration set of a numb er of times of repeated Msg3-PUSCH transmission corresponding to the second uplink transmission format,
wherein the configuration set of the number of times of repeated Msg3-PUSCH transmission is used to determine the number of times of repeated Msg3-PUSCH transmission.

11. The terminal device according to claim 2, wherein the processor is further configured to perform an operation of:
determining the target uplink transmission format from the at least one uplink transmission format independently; or
determining the target uplink transmission format from the at least one uplink transmission format based on an indication from the network device.

12. A network device, comprising a processor configured to perform operations of:
sending first configuration information to a terminal device, wherein the first configuration information is used to determine at least one uplink transmission format, the at least one uplink transmission format comprises a first uplink transmission format, and the first uplink transmission format is different from a basic transmission format; and
receiving uplink transmission sent by the terminal device based on a target uplink transmission format, wherein the target uplink transmission format is determined from the at least one uplink transmission format.

13. The network device according to claim 12, wherein the first configuration information is used to determine a configuration parameter of the at least one uplink transmission format.

14. The network device according to claim 13, wherein a quantity of configuration parameters is configured in the first configuration information, or is predefined.

15. The network device according to claim 13, wherein a configuration parameter of at least a part of the at least one uplink transmission format is used to determine a first RO set; and in the first RO set, an association rule among a preamble, an RO, and an SSB comprises at least one of the following:
each RO is associated with N SSBs, each SSB corresponds to R preambles used for contention access, N is a positive integer or 1/N is a positive integer, and R is a positive integer; and
an arrangement order of preambles, ROs, and SSBs is as follows: first, preambles are arranged in an ascending order of preamble indexes within each RO, second, ROs for frequency division multiplexing are arranged in an ascending order of frequency domain resource indexes, and finally, ROs for time division multiplexing are arranged in an ascending order of time domain resource indexes; or first, ROs for frequency division multiplexing are arranged in an ascending order of frequency domain resource indexes, and second, ROs for time division multiplexing are arranged in an ascending order of time domain resource indexes.

16. The network device according to claim 12, wherein the at least one uplink transmission format further comprises a second uplink transmission format, and the second uplink transmission format is the same as the basic transmission format or the second uplink transmission format is different from the basic transmission format.

17. The network device according to claim 16, wherein the uplink transmission is PRACH transmission or MsgA transmission; and
an RAR format corresponding to the first uplink transmission format is the same as an RAR format corresponding to the second uplink transmission format.

18. The network device according to claim 16, wherein the uplink transmission is PRACH transmission; and
an RAR format corresponding to the first uplink transmission format is a first RAR format, an RAR format corresponding to the second uplink transmission format is a second RAR format, and the first RAR format is different from the second RAR format and/or an information field in an uplink grant comprised in the first RAR format is different from an information field in an uplink grant comprised in the second RAR format and/or a PUCCH resource configuration corresponding to the first RAR format is different from a PUCCH resource configuration corresponding to the second RAR format; and/or
a configuration set of a number of times of repeated Msg3-PUSCH transmission corresponding to the first uplink transmission format is different from or same as a configuration set of a number of times of repeated Msg3-PUSCH transmission corresponding to the second uplink transmission format; wherein the configuration set of the number of times of repeated Msg3-PUSCH transmission is used to determine the number of times of repeated Msg3-PUSCH transmission.

19. The network device according to claim 16, wherein the uplink transmission is MsgA transmission; and
an RAR format corresponding to the first uplink transmission format is a first RAR format, an RAR format corresponding to the second uplink transmission format is a second RAR format, and the first RAR format is different from the second RAR format and/or a PUCCH resource configuration corresponding to the first RAR format is different from a PUCCH resource configuration corresponding to the second RAR format.

20. The network device according to claim 12, wherein the processor is further configured to perform an operation of:
indicating the target uplink transmission format to the terminal device.
